(19) United States
(12) Patent Application Publication
(10) Pub. No.: US 2025/0391836 A1
(43) Pub. Date: Dec. 25, 2025

(54) NONAQUEOUS ELECTROLYTE SECONDARY BATTERY, BATTERY MODULE, AND BATTERY SYSTEM

(71) Applicant: SEKISUI CHEMICAL CO., LTD., Osaka (JP)

(72) Inventors: Hikaru YOSHIKAWA, Tsukuba-shi (JP); Junya IINO, Tsukuba-shi (JP)

(73) Assignee: SEKISUI CHEMICAL CO., LTD., Osaka (JP)

(21) Appl. No.: 19/102,547

(22) PCT Filed: Sep. 4, 2023
(86) PCT No.: PCT/JP2023/032239

§ 371 Date: Feb. 10, 2025

(30) Foreign Application Priority Data
Sep. 5, 2022 (JP) 2022-140838

(51) Int. Cl. H01M 4/136; H01M 4/02; H01M 4/36; H01M 4/58; H01M 4/62; H01M 4/66; H01M 10/0568; H01M 10/0585

(52) U.S. Cl. CPC H01M 4/136; H01M 4/366; H01M 4/5825; H01M 4/625; H01M 4/663; H01M 4/667; H01M 10/0568; H01M 10/0585; H01M 2004/028; H01M 2300/0025

(57) ABSTRACT

This nonaqueous electrolyte secondary battery includes a positive electrode, a negative electrode, and a nonaqueous electrolyte present between these electrodes. The positive electrode has a current collector with a positive electrode active material layer containing at least one type of positive electrode active material particles present on one or both surfaces. When 1,000 cycles of constant current charging to an end voltage of not more than 3.8 V and constant current discharging to an end voltage of 2.5 V are repeated at a 3 C rate current, at the point of a state of charge (SOC) of 50% on a discharge curve plotted with the voltage along the vertical axis and the SOC of the cell along the horizontal axis, the voltage difference V1-V2 between the voltage V1 of the first cycle and the voltage V2 of the 1,000th cycle is at least 0.1 mV but not more than 5.0 mV.

### TECHNICAL FIELD

The present invention relates to a nonaqueous electrolyte secondary battery, and a battery module and battery system containing the nonaqueous electrolyte secondary battery.

Priority is claimed on Japanese Patent Application No. 2022-140838, filed Sep. 5, 2022, the content of which is incorporated herein by reference.

### BACKGROUND ART

Nonaqueous electrolyte secondary batteries are generally composed of a positive electrode, a nonaqueous electrolyte, a negative electrode, and a separation membrane (hereinafter also referred to as a “separator”) disposed between the positive electrode and the negative electrode.

One known example of the positive electrode of a nonaqueous electrolyte secondary battery is an electrode having a composition composed of a positive electrode active material containing lithium ions, a conductive assistant and a binder fixed to the surface of a metal foil that functions as the current collector.

Examples of materials that are used as the positive electrode active material containing lithium ions include lithium transition metal composite oxides such as lithium cobalt oxide, lithium nickel oxide and lithium manganese oxide, and lithium phosphate compounds such as lithium iron phosphate.

Conventionally, one known method for improving the cycle characteristics of nonaqueous electrolyte secondary batteries is a method in which, for example, in a positive electrode containing a lithium transition metal composite oxide as the positive electrode active material, by storing the positive electrode in a gas containing oxygen and water vapor following formation of the electrode, side reactions at the positive electrode surface that typically accompany the battery reactions can be suppressed (for example, see Patent Document 1).

Further, it is also known that by including active material particles coated with a coating layer containing a conductive agent and a solid electrolyte within at least one of the positive electrode and the negative electrode, the coating layer functions as a layer of superior mechanical strength containing a hard glass-like solid electrolyte as the main component, which counteracts the swelling forces of the active material particles during charging and discharging and suppresses deformation of the active material particles. This enables effective suppression of loosening of the electrode caused by charging and discharging, and swelling of the electrode and battery, enabling prevention of any deterioration in the charge/discharge cycle characteristics or high rate discharge characteristics. Further, favorable contact is maintained between the electrode and the battery container, meaning any increase in the battery internal resistance as a result of charge/discharge cycles can also be prevented (for example, see Patent Document 2).

### CITATION LIST

### Patent Documents

Patent Document 1: Japanese Unexamined Patent Application, First Publication No. 2001-325947
Patent Document 2: Japanese Unexamined Patent Application, First Publication No. 2003-59492

### SUMMARY OF INVENTION

### Technical Problem

In Patent Document 1, although increases in the internal resistance of the nonaqueous electrolyte secondary battery are reduced, a resistance increase of at least 10% still occurs after 500 charge/discharge cycles, indicating that an entirely satisfactory effect is not attainable.

In Patent Document 2, in an example which used a positive electrode active material in which the surface of LiCoO2 had been coated with a solid electrolyte and a conductive material, and in which a conductive material had also been added, although an improvement in the cycle characteristics is reported, no comment is made regarding increases in the resistance.

The present invention has been developed in light of the above circumstances, and has the objects of providing a nonaqueous electrolyte secondary battery which exhibits excellent cycle characteristics and in which any increase in the resistance following charge/discharge cycles is suppressed, and also providing a battery module and a battery system which contain the nonaqueous electrolyte secondary battery, and provide superior estimation accuracy relating to residual capacity following charge/discharge cycles.

### Solution to Problem

The present invention has the following configurations.

[1] A nonaqueous electrolyte secondary battery containing a positive electrode, a negative electrode, and a nonaqueous electrolyte present between the positive electrode and the negative electrode, wherein the positive electrode includes a current collector, and a positive electrode active material layer containing at least one type of positive electrode active material particles present on one surface or both surfaces of the current collector, and when 1,000 cycles of constant current charging to an end voltage of not more than 3.8 V and constant current discharging to an end voltage of 2.5 V are repeated at a 3 C rate current, at the point of a state of charge (SOC) of 50% on a discharge curve plotted with the voltage along the vertical axis and the SOC of the cell along the horizontal axis, the voltage difference V1-V2 between the voltage V1 of the first cycle and the voltage V2 of the 1,000th cycle is at least 0.1 mV but not more than 5.0 mV.
[2] The nonaqueous electrolyte secondary battery according to [1], wherein the end voltage of the constant current charging is within a range from 3.5 to 3.8 V.
[2-1] The nonaqueous electrolyte secondary battery according to [1], wherein the end voltage of the constant current charging is within a range from 3.5 to 3.6 V.
[2-2] The nonaqueous electrolyte secondary battery according to [1], wherein the end voltage of the constant current charging is 3.5.
[3] The nonaqueous electrolyte secondary battery according to [1], wherein when 1,000 cycles of constant current charging to an end voltage of not more than 3.8 V and constant current discharging to an end voltage of 2.5 V are repeated at a 3 C rate current, the initial 3 C discharge capacity rate determined by dividing the discharge capacity of the first cycle by the capacity when the discharge capacity was confirmed in advance is 80% or higher.
[4] The nonaqueous electrolyte secondary battery according to [1], wherein a current collector coating layer containing conductive carbon is present on at least a portion of the surface of the current collector on the side of the positive electrode active material layer.
[5] The nonaqueous electrolyte secondary battery according to [1], wherein a current collector coating layer containing conductive carbon is present on at least a portion of the surface of the current collector on the side of the positive electrode active material layer, and an active material coating portion containing a conductive material is present on
at least a portion of the surfaces of the positive electrode active material particles.
   [6] The nonaqueous electrolyte secondary battery according to [1], wherein the nonaqueous electrolyte contains a lithium imide salt.
   [7] The nonaqueous electrolyte secondary battery according to [6], wherein the lithium imide salt is represented by a formula (1) shown below:

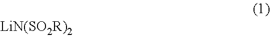

[wherein R represents a fluorine atom or CₓF₍₂ₓ₊₁₎, and x represents an integer of 1 to 3].
[8] The nonaqueous electrolyte secondary battery according to [1], wherein the positive electrode active material particles contain at least a compound represented by a general formula: LiFeₓM₍₁₋ₓ₎PO₄ (wherein 0≤x≤1, and M represents Co, Ni, Mn, Al, Ti or Zr).
[8-1] The nonaqueous electrolyte secondary battery according to [1], wherein the positive electrode active material particles include particles of lithium iron phosphate represented by LiFePO₄.
[9] The nonaqueous electrolyte secondary battery according to [1], wherein the amount of conductive carbon relative to the total mass of the positive electrode active material layer is at least 0.5% by mass but less than 3.5% by mass.
[10] A battery module or battery system provided with a plurality of the nonaqueous electrolyte secondary batteries according to any one of [1] to [9].

Another aspect of the present invention includes the following configurations.

[11] A nonaqueous electrolyte secondary battery containing a positive electrode, a negative electrode, and a nonaqueous electrolyte present between the positive electrode and the negative electrode, wherein
the positive electrode includes a current collector, and a positive electrode active material layer containing at least one type of positive electrode active material particles present on one surface or both surfaces of the current collector,
when 1,000 cycles of constant current charging to an end voltage of at least 3.4 V but not more than 3.8 V and constant current discharging to an end voltage of 2.5 V are repeated at a 3 C rate current, at the point of a state of charge (SOC) of 50% on a discharge curve plotted with the voltage along the vertical axis and the SOC of the cell along the horizontal axis, the voltage difference V1-V2 between the voltage V1 of the first cycle and the voltage V2 of the 1,000th cycle is at least 0.1 mV but not more than 5.0 mV.
a current collector coating layer containing conductive carbon is present on at least a portion of the surface of the current collector on the side of the positive electrode active material layer,
an active material coating portion containing a conductive material is present on at least a portion of the surfaces of the positive electrode active material particles,
the positive electrode active material particles contain at least a compound represented by a general formula: LiFeₓM₍₁₋ₓ₎PO₄ (wherein 0≤x≤1, and M represents Co, Ni, Mn, Al, Ti or Zr),
the negative electrode includes a current collector, and a negative electrode active material layer containing at least one type of negative electrode active material particles present on one surface or both surfaces of the current collector, and
the negative electrode active material particles are composed of a carbon material or silicon.
   [12] The nonaqueous electrolyte secondary battery according to [1], wherein when 1,000 cycles of constant current charging to an end voltage of at least 3.4 V but not more than 3.8 V and constant current discharging to an end voltage of 2.5 V are repeated at a 3 C rate current, the initial 3 C discharge capacity rate determined by dividing the discharge capacity of the first cycle by the capacity when the discharge capacity was confirmed in advance is 80% or higher.
   [13] The nonaqueous electrolyte secondary battery according to [11] or [12], wherein the nonaqueous electrolyte contains a lithium imide salt.
   [14] The nonaqueous electrolyte secondary battery according to [13], wherein the lithium imide salt is represented by a formula (1) shown below:

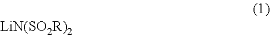

[wherein R represents a fluorine atom or CₓF₍₂ₓ₊₁₎, and x represents an integer of 1 to 3].
[15] The nonaqueous electrolyte secondary battery according to any one of to
[14], wherein the amount of conductive carbon relative to the total mass of the positive electrode active material layer is at least 0.5% by mass but less than 3.5% by mass.
[16] A battery module or battery system provided with a plurality of the nonaqueous electrolyte secondary batteries according to any one of [11] to [15].

### Advantageous Effects of Invention

The present invention is able to provide a nonaqueous electrolyte secondary battery which exhibits excellent cycle characteristics and in which any increase in the resistance following charge/discharge cycles is suppressed, and can also provide a battery module and a battery system which contain the nonaqueous electrolyte secondary battery, and provide superior estimation accuracy relating to residual capacity following charge/discharge cycles.

### BRIEF DESCRIPTION OF DRAWINGS

FIG. 1 is a cross-sectional view schematically illustrating one example of a nonaqueous electrolyte secondary battery according to the present invention.

FIG. 2 is a cross-sectional view schematically illustrating one example of a positive electrode for a nonaqueous electrolyte secondary battery according to the present invention.

FIG. 3 is a perspective view illustrating a nonaqueous electrolyte secondary battery (cell) produced in the examples and comparative examples.

FIG. 4 is a perspective view illustrating a nonaqueous electrolyte secondary battery module produced in the examples and comparative examples.

FIG. 5 is a perspective view illustrating a nonaqueous electrolyte secondary battery module produced in the examples and comparative examples.

FIG. 6 is a diagram illustrating discharge curves representing the relationship between the voltage and the SOC for the first charge/discharge cycle and the 1,000th charge/discharge cycle of a nonaqueous electrolyte secondary battery in Example 1.

FIG. 7 is a diagram illustrating discharge curves representing the relationship between the voltage and the SOC for the first charge/discharge cycle and the 1,000th charge/discharge cycle of a nonaqueous electrolyte secondary battery module in Example 1.

### DESCRIPTION OF EMBODIMENTS

In the description and in the claims, an expression “a to b” denoting a numerical range is deemed to include the numerical values of a and b as the lower limit and upper limit respectively.

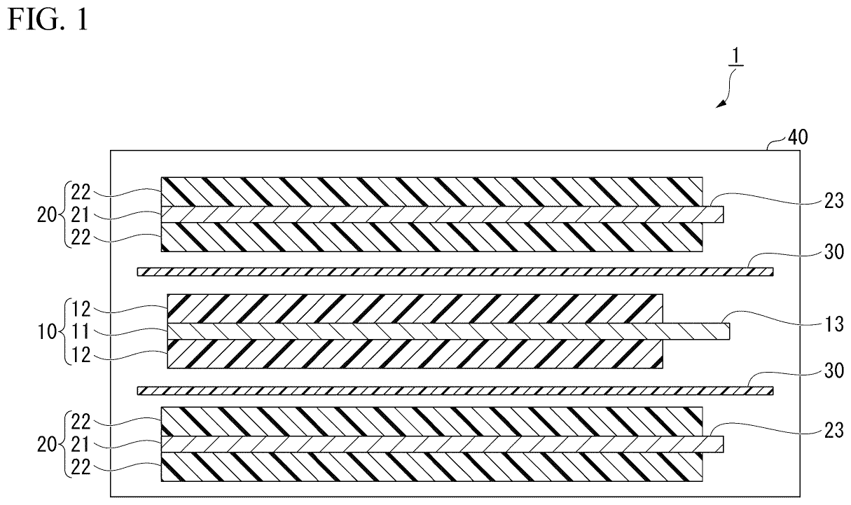

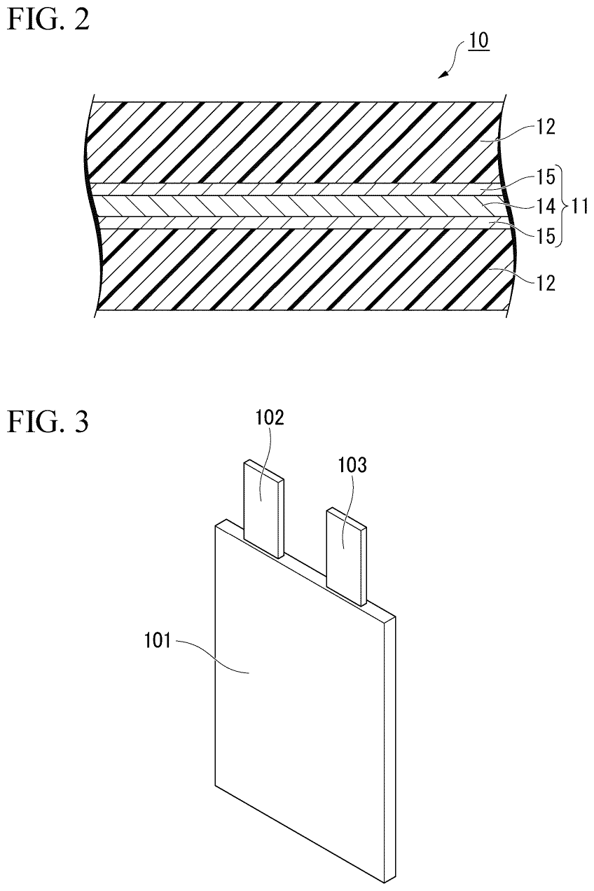

FIG. 1 is a schematic cross-sectional view illustrating one embodiment of a positive electrode for a nonaqueous electrolyte secondary battery of the present invention. FIG. 2 is a schematic cross-sectional view schematically illustrating one embodiment of a nonaqueous electrolyte secondary battery according to the present invention.

FIG. 1 and FIG. 2 are drawings for facilitating description of the structures, and the dimensional ratios and the like of the various structural elements may sometimes differ from the actual values.

### <Nonaqueous Electrolyte Secondary Battery>

A nonaqueous electrolyte secondary battery 1 of the embodiment of the present invention illustrated in FIG. 1 contains a nonaqueous electrolyte secondary battery positive electrode (hereinafter also referred to as simply the “positive electrode”) 10, a negative electrode 20, and a nonaqueous electrolyte. The nonaqueous electrolyte secondary battery 1 of this embodiment may also include a separator 30. In FIG. 1, numeral 40 represents the external case.

In the present embodiment, the positive electrode 10 includes a plate-like positive electrode current collector 11, and positive electrode active material layers 12 provided on both surfaces thereof. The positive electrode active material layers 12 are present on a portion of the surfaces of the positive electrode current collector 11.

The end portion of the surfaces of the positive electrode current collector 11 represents a positive electrode current collector exposed portion 13 where the positive electrode active material layers 12 are absent. A terminal tab not shown in the drawing is connected electrically to an arbitrary location of the positive electrode current collector exposed portion 13.

The negative electrode 20 includes a plate-like negative electrode current collector 21, and negative electrode active material layers 22 provided on both surfaces thereof. The negative electrode active material layers 22 are present on a portion of the surfaces of the negative electrode current collector 21. The end portion of the surfaces of the negative electrode current collector 21 represents a negative electrode current collector exposed portion 23 where the negative electrode active material layers 22 are absent. A terminal tab not shown in the drawing is connected electrically to an arbitrary location of the negative electrode current collector exposed portion 23.

There are no particular limitations on the shapes of the positive electrode 10, the negative electrode 20 and the separator 30. For example, the shapes may be rectangular when viewed in plan view.

The nonaqueous electrolyte secondary battery 1 of the present embodiment can be produced, for example, by a method in which an electrode laminate is first produced in which the positive electrode 10 and the negative electrode 20 are laminated alternately with the separator 30 disposed therebetween, the electrode laminate is then enclosed in the external case 40 composed of an aluminum laminated pouch or the like, the nonaqueous electrolyte (not shown in the drawing) is injected into the external case, and the entire structure is then sealed.

In FIG. 1, a laminated structure having negative electrode/separator/positive electrode/separator/negative electrode laminated in that order is illustrated as a representative example, but the number of electrodes may be altered as appropriate. There may be one or more positive electrodes 10, and an appropriate number of positive electrodes 10 may be used in accordance with the desired battery capacity. The numbers of negative electrodes 20 and separators 30 is one greater than the number of positive electrodes 10, and the lamination is conducted so that the negative electrodes 20 represent the outermost layers.

The nonaqueous electrolyte secondary battery 1 of the present embodiment is configured such that when 1,000 cycles of constant current charging to an end voltage of not more than 3.8 V and constant current discharging to an end voltage of 2.5 V are repeated at a 3 C rate current, at the point of a state of charge (SOC) of 50% on a discharge curve plotted with the voltage along the vertical axis and the SOC of the cell along the horizontal axis, the voltage difference V1-V2 between the voltage V1 of the first cycle and the voltage V2 of the 1,000th cycle is at least 0.1 mV but not more than 5.0 mV. The voltage difference V1-V2 is preferably at least 0.1 mV but not more than 4.0 mV, and more preferably at least 0.1 mV but not more than 3.0 mV. If the voltage difference V1-V2 is less than the above lower limit, then degradation due to resistance increase is too small, meaning it becomes difficult to schedule maintenance or determine the replacement frequency when the battery is used in a battery pack, which is impractical. In contrast, if the voltage difference V1-V2 exceeds the above upper limit, then the resistance degradation when a battery pack is produced is too large, and the required frequency for maintenance and replacement increase to an impractical level. Provided the voltage difference V1-V2 is at least 0.1 mV, degradation due to resistance increase is not too small, and the maintenance and replacement frequency can be set more easily when a battery pack is produced. Further, provided the voltage difference V1-V2 is not more than 5.0 mV, the resistance degradation when a battery pack is produced is not too large, and the required frequency for maintenance and replacement is not too high.

The above voltage difference V1-V2 can be adjusted by factors such as the type and amount of active material incorporated in the positive electrode active material layer, the amount of conductive carbon, the amount of conductive assistant, the presence or absence of a current collector coating layer, the type of electrolyte material contained in the electrolyte solution, and the upper limit voltage used during the battery charge/discharge cycles.

The end voltage for the above constant current charging is not more than 3.8 V, and is preferably within a range from 3.5 to 3.8 V, more preferably from 3.5 to 3.6 V, and even more preferably 3.5 V. If the end voltage of the constant current charging is less than the above lower limit, then charging is halted at a voltage lower than a fully charged state, meaning the amount of energy that can be charged and discharged is reduced. Further, if the end voltage of the constant current charging exceeds the above upper limit, then oxidative degradation of the electrolyte solution and the electrolyte at high voltage becomes more likely, the increase in battery resistance is greater, and the value for the voltage difference V1-V2 increases, causing a deterioration in the charge/discharge cycle characteristics. Provided that the end voltage of the constant current charging is not more than 3.8 V, a state that is close to a fully charged state can be achieved by the constant current charging. Further, provided the end voltage of the constant current charging is not more than 3.8 V, oxidative degradation of the electrolyte solution and the electrolyte at high voltage is unlikely, and deterioration during the charge/discharge cycles is less likely to occur.

In those cases where the conductive material incorporated in the coating portion of the positive electrode active material particles is conductive carbon, a TEM-EELS spectrum obtained by subjecting the positive electrode active material particles to measurement by transmission electron microscope electron energy loss spectroscopy (TEM-EELS) can be used to determine the presence or absence of a coating portion on the positive electrode active material particles, and as an indicator of the amount of conductive carbon present in the coating portion.

Specifically, it is known that the TEM-EELS spectrum of a carbon material begins to rise between 280 and 285 eV, and exhibits a peak attributable to sp² bonding in the vicinity of 285 eV. Accordingly, in the TEM-EELS spectrum of the positive electrode active material particles, the existence of a peak within a range from 280 to 290 eV confirms the existence of a coating portion containing conductive carbon.

Further, a larger value for the ratio P₂₈₅/P₂₈₀ representing the ratio of the peak intensity P₂₈₅ at 285 eV relative to the peak intensity P₂₈₀ at 280 eV indicates a larger amount of conductive carbon present in the coating portion of the positive electrode active material particles.

In terms of making it easier to obtain an appropriate quantity of coating on the surface of the positive electrode active material layer, the value of P₂₈₅/P₂₈₀ is preferably at least 10.0, and more preferably 100.0 or greater.

In this description, a TEM-EELS spectrum of the positive electrode active material particles is measured using a method described below.

In the nonaqueous electrolyte secondary battery 1 of the present embodiment, when 1,000 cycles of constant current charging to an end voltage of not more than 3.8 V and constant current discharging to an end voltage of 2.5 V are repeated at a 3 C rate current, the initial 3 C discharge capacity rate determined by dividing the discharge capacity of the first cycle by the capacity when the discharge capacity was confirmed in advance is preferably at least 80%, more preferably at least 88%, and even more preferably 93% or higher.

### [Positive Electrode]

The positive electrode 10 illustrated in FIG. 2 includes the positive electrode current collector 11 and the positive electrode active material layer 12. The positive electrode active material layer 12 is present on at least one surface of the positive electrode current collector 11. Positive electrode active material layers 12 may also be present on both surfaces of the positive electrode current collector 11.

In the example illustrated in FIG. 2, the positive electrode current collector 11 includes a positive electrode current collector main body 14, and current collector coating layers 15 coating the surfaces of the positive electrode current collector main body 14 on the sides of the positive electrode active material layers 12. The positive electrode current collector 11 may also be composed solely of the positive electrode current collector main body 14.

### [Positive Electrode Active Material Layer]

The positive electrode active material layer 12 contains the positive electrode active material. The positive electrode active material layer 12 preferably also contains a binder. The positive electrode active material layer 12 may also contain a conductive assistant.

The positive electrode active material particles contain the positive electrode active material. The positive electrode active material particles may be particles composed solely of the positive electrode active material, or may be particles having a core portion of the positive electrode active material and a coating portion (also called an active material coating portion) that coats the core portion (namely, so-called coated particles). It is preferable that at least a portion of the group of positive electrode active material particles contained in the positive electrode active material layer 12 are coated particles.

The amount of the positive electrode active material relative to the total mass of the positive electrode active material layer 12 is preferably within a range from 80.0% by mass to 99.9% by mass, and more preferably from 90.0% by mass to 99.5% by mass.

The positive electrode active material preferably contains at least a compound having an olivine-type crystal structure.

The compound having an olivine-type crystal structure is preferably a compound represented by a general formula: LiFeₓM₍₁₋ₓ₎PO₄ (hereinafter also referred to as “general formula (1)”). In general formula (1), 0≤x≤1. Further, M represents Co, Ni, Mn, Al, Ti or Zr. Trace amount portions of the Fe and M (Co, Ni, Mn, Al, Ti or Zr) may be substituted with other elements, provided that the physical properties do not change. The effects of the present invention are not impaired even if the compound represented by general formula (1) contains trace amounts of metal impurities.

The compound represented by general formula (1) is preferably lithium iron phosphate represented by LiFePO₄ (hereinafter also referred to as simply “lithium iron phosphate”).

The positive electrode active material may also contain one or more other positive electrode active materials besides the compound having an olivine-type crystal structure.

This other positive electrode active material is preferably a lithium transition metal composite oxide. Examples include lithium cobalt oxide, lithium nickel oxide, lithium nickel cobalt oxide (LiNiₓCo_{y}Al₂O₂, wherein x+y+z=1), lithium nickel cobalt manganese oxide (LiNiₓCo_{y}Mn₂O₂, wherein x+y+z=1), lithium manganese oxide, lithium cobalt manganese oxide, lithium chromium manganese oxide, lithium vanadium nickel oxide, nickel-substituted lithium manganese oxide (for example, LiMn_{1.5}Ni_{0.5}O₄) and lithium vanadium cobalt oxide (LiCoVO₄), as well as non-stoichiometric compounds in which a portion of one of the above compounds has been substituted with another metal element. Examples of this other metal element include one or more metals selected from the group consisting of Mn, Mg, Ni, Co, Cu, Zn and Ge.

The other positive electrode active material may be composed of one type or two or more types of material.

In the positive electrode active material particles of the present embodiment, it is preferable that at least a portion of the surface of the positive electrode active material is covered with a conductive material, and coated particles in which an active material coating portion containing a conductive material is present on at least a portion of the surface of the positive electrode active material are preferred. In terms of achieving superior battery capacity and cycle characteristics, coated particles in which the entire surface of the positive electrode active material is coated with the conductive material are particularly preferred. By using coated particles as the positive electrode active material particles, the battery capacity and high rate cycle characteristics can be further improved.

For example, the active material coating portion may be formed in advance on the surfaces of the positive electrode active material particles, and may exist on the surfaces of the positive electrode active material particles within the positive electrode active material layer. In other words, the active material coating portion in this description is not a portion that is newly formed in a step following the preparation stage of the composition for producing the positive electrode. In addition, the active material coating portion cannot be easily removed in a step following the preparation stage of the composition for producing the positive electrode.

For example, during preparation of the composition for producing the positive electrode, even if the coated particles are mixed with a solvent in a mixer or the like, the active material coating portion remains covering the surface of the positive electrode active material particles. Further, even if the positive electrode active material layer were to be detached from the positive electrode and placed in a solvent, thereby dissolving the binder within the positive electrode active material layer in the solvent, the active material coating portion remains covering the surface of the positive electrode active material particles. Furthermore, even if aggregated particles were to be subjected to a loosening operation during measurement of the particle size distribution of particles in the positive electrode active material layer by a laser diffraction and scattering method, the active material coating portion remains covering the surface of the positive electrode active material particles.

The active material coating portion is preferably present on at least 50% of the total external surface area of the positive electrode active material particles, and is more preferably present on at least 70%, and even more preferably 90% or more, of the total external surface area.

In other words, the coated particles preferably includes a core portion composed of the positive electrode active material and an active material coating portion that covers the surface of the core portion, and the surface area of the active material coating portion relative to the total surface area of the core portion (also referred to as the coverage rate) is preferably at least 50%, more preferably at least 70%, and even more preferably 90% or higher.

The surface area of the active material coating portion can be determined by analyzing the particles in the positive electrode active material layer by transmission electron microscopy energy-dispersive X-ray spectroscopy (TEM-EDX) and conducting an elemental analysis by EDX of the outer peripheral portion of the positive electrode active material particles. The elemental analysis is conducted for carbon to identify the carbon covering the positive electrode active material particles. Locations in which the coating portion of carbon has a thickness of at least 1 nm are identified as coating portions, the proportion of these coating portions relative to the total outer periphery of the analyzed positive electrode active material particles is determined, and this value is deemed the coverage rate. The measurement may be conducted, for example, for 10 individual positive electrode active material particles, and the average value for those 10 particles then deemed the coverage rate.

Measurement of the coverage rate can also be calculated by using TEM-EDX to conduct element mapping of the positive electrode active material particles using an element specific to the positive electrode active material and an element specific to the conductive material contained in the active material coating portion. In a similar manner to that described above, the coverage rate can be determined by identifying locations in the active material coating portion in which the thickness of the element specific to the conductive material has a thickness of at least 1 nm as coating portions, and determining the proportion of these coating portions relative to the total outer periphery of the positive electrode active material particles being analyzed. This measurement may be conducted, for example, for 10 individual positive electrode active material particles, and the average value for those 10 particles then deemed the coverage rate.

The active material coating portion is a layer formed directly onto the surface of particles composed solely of the positive electrode active material (hereinafter, also referred to as the “core portion”). The thickness of the active material coating portion of the positive electrode active material is preferably within a range from 1 to 100 nm. Provided the thickness of the active material coating portion of the positive electrode active material is within this range from 1 to 100 nm, the aforementioned voltage difference V1-V2 can be more easily controlled within the above range.

The thickness of the active material coating portion of the positive electrode active material can be measured using a method in which the thickness of the active material coating portion in a transmission electron microscope (also referred to as TEM) image of the positive electrode active material is measured. The thickness of the active material coating portion present on the surface of the positive electrode active material need not be uniform. An active material coating portion with a thickness of at least 1 nm is preferably present on at least a portion of the surface of the positive electrode active material, and the maximum value for the thickness of the active material coating portion is preferably not more than 100 nm.

In the present invention, within the coated particles, it is particularly desirable that the surface area of the active material coating portion relative to the surface area of the core portion is 100%.

This coverage rate represents the average value for all of the positive electrode active material particles present in the positive electrode active material layer, and this average value need only be as large as the above lower limit, and does not preclude the presence of a small amount of positive electrode active material particles not having an active material coating portion. In those cases where positive electrode active material particles not having an active material coating portion (simple particles) are present in the positive electrode active material layer, the amount of these simple particles relative to the total amount of all the positive electrode active material particles present in the positive electrode active material layer is preferably not more than 30%, more preferably not more than 20%, and even more preferably 10% or less.

The conductive material of the active material coating portion preferably contains carbon (conductive carbon). The conductive material may be composed solely of carbon, or may be a conductive organic compound containing carbon and one or more elements other than carbon. Examples of these other elements include nitrogen, hydrogen and oxygen. In the conductive organic compound mentioned above, the amount of other elements is preferably not more than 10 atom %, and more preferably 5 atom % or lower.

It is even more desirable that the conductive material that constitutes the active material coating portion is composed solely of carbon.

The amount of the conductive material relative to the total mass of the positive electrode active material having the active material coating portion is preferably within a range from 0.1 to 4% by mass, more preferably from 0.1 to 3.0% by mass, even more preferably from 0.5 to 3.0% by mass, still more preferably from 0.7 to 2.5% by mass, still more preferably from 0.5 to 1.5% by mass, and particularly preferably from 0.7 to 1.3% by mass. If the amount of the conductive material is too large, then there is a possibility that the conductive material may detach from the surface of the positive electrode active material and be retained as an independent conductive assistant particle, which is not desirable. Provided the amount of the conductive material relative to the total mass of the positive electrode active material having the active material coating portion is not more than 3.0% by mass, detachment of the conductive material from the surface of the positive electrode active material is unlikely. Provided the amount of the conductive material relative to the total mass of the positive electrode active material having the active material coating portion is at least 0.1% by mass, almost all contact between active material particles occurs via the conductive material, which contributes to an improvement in the conductivity within the positive electrode active material layer.

Conductive particles that do not contribute to the conduction path may act as the source of battery self-discharge or undesirable side reactions.

In those cases where the active material coating portion is composed of carbon, the resistivity of the active material surface is preferably adjusted within a range from 10⁶ to 10⁹ Ω. In those cases where the surface is coated with a highly conductive carbon black, carbon nanotubes or graphene or the like, the resistivity tends to be too low, and when the charge/discharge cycle is conducted, side reactions with the electrolyte tend to increase, resulting in an undesirable deterioration in the battery lifespan characteristics. The resistivity of the active material surface can be measured, for example, using a scanning spread resistance microscope.

The coated particles are preferably particles containing a compound having an olivine-type crystal structure as the core portion, more preferably coated particles containing a compound represented by general formula (1) as the core portion, and even more preferably coated particles containing lithium iron phosphate as the core portion (hereinafter also sometimes referred to as “coated lithium iron phosphate”). Provided these types of coated particles are used, the battery capacity and cycle characteristics can be further improved.

In addition, it is particularly desirable that the coated particles have the entire surface of the core portion coated with the conductive material.

The coated particles can be produced by conventional methods. One method for producing the coated particles is described below, using coated lithium iron phosphate as an example.

There are no particular limitations on the production method used for obtaining lithium iron phosphate particles coated with carbon, and examples include methods in which a carbon coating is formed on the surfaces of the lithium iron phosphate particles by conducting a heat treatment at 600 to 1,300° C. using an easily graphitizable resin, a non-graphitizable resin, naphthalene, coal tar, or binder pitch or the like as a precursor, or by conducting a chemical vapor deposition (CVD) treatment using hydrocarbon compounds such as methanol, ethanol, benzene and toluene as the chemical deposition carbon source at a heat treatment temperature within a range from 600 to 1,300° C. with the lithium iron phosphate particles under flow conditions.

In another positive electrode active material, the active material coating portion may be present on at least a portion of the surface.

The amount of the coated particles relative to the total mass of the positive electrode active material particles is preferably at least 50% by mass, more preferably at least 80% by mass, and even more preferably 90% by mass or greater. This amount may be 100% by mass.

The amount of the compound having an olivine-type crystal structure relative to the total mass of the positive electrode active material particles (including the mass of the active material coating portion in those cases where the active material includes a coating portion) is preferably at least 50% by mass, more preferably at least 80% by mass, and even more preferably 90% by mass or greater. The amount of the compound having an olivine-type crystal structure relative to the total mass of the positive electrode active material particles may be 100% by mass.

In those cases where coated lithium iron phosphate is used, the amount of the coated lithium iron phosphate relative to the total mass of the positive electrode active material particles is preferably at least 50% by mass, more preferably at least 80% by mass, and even more preferably 90% by mass or greater. The amount of the coated lithium iron phosphate relative to the total mass of the positive electrode active material particles may be 100% by mass.

The amount of the positive electrode active material particles relative to the total mass of the positive electrode active material layer 12 is preferably at least 90% by mass, more preferably at least 95% by mass, even more preferably greater than 99% by mass, still more preferably at least 99.5% by mass, and may be 100% by mass. Provided the amount of the positive electrode active material particles is at least as large as the above lower limit, the battery capacity and the cycle characteristics can be further enhanced.

The carbon of the active material coating portion can be formed using conventional methods.

In those cases where the active material coating portion is composed of carbon, amorphous carbon is preferred.

There are no particular limitations on the production method used for obtaining a positive electrode active material coated with amorphous carbon, and examples include conventional methods in which a carbon coating film is formed on the surfaces of the positive electrode active material particles by conducting a heat treatment at 600 to 1,300° C. using an easily graphitizable resin, a non-graphitizable resin, naphthalene, coal tar, or binder pitch or the like as a precursor, or by conducting a chemical vapor deposition (CVD) treatment using hydrocarbon compounds such as methanol, ethanol, benzene or toluene as the chemical deposition carbon source at a heat treatment temperature within a range from 600 to 1,300° C. with the lithium iron phosphate particles under flow conditions. The majority of the carbon that constitutes the active material coating portion formed from these methods is amorphous.

In those cases where the active material coating portion is not amorphous, but is rather formed using carbon nanotubes or graphene or the like with high conductivity and high crystallinity, the resistivity of the active material coating portion becomes too low, and when the charge/discharge cycle is conducted, side reactions with the electrolyte tend to increase, resulting in a deterioration in the battery lifespan characteristics.

For example, by confirming the proportion of sp² bonding based on the difference in the form of the EELS spectrum (C-K edge), a determination can be made as to whether the carbon of the active material coating portion is crystalline or amorphous. Similarly, by confirming the peak location in the Raman spectrum within the wavenumber range from 1,200 cm⁻¹ to 1,800 cm⁻¹, a determination can be made as to whether the carbon of the active material coating portion is crystalline or amorphous.

In the active material coating portion, the abundance ratio of amorphous carbon is preferably higher than the abundance ratio of crystalline carbon. Specifically, the ratio of amorphous carbon relative to crystalline carbon (amorphous carbon/crystalline carbon) in the active material coating portion is preferably at least 1.2, more preferably at least 1.6, and particularly preferably 2.0 or greater. The determination as to whether the carbon of the active material coating portion is crystalline or amorphous can be made by confirming the proportion of sp² bonding based on the difference in the form of the EELS spectrum (C-K edge). For example, EELS spectra may be measured at 20 locations on the surface of the positive electrode active material, with the abundance ratio of crystalline carbon and the abundance ratio of amorphous carbon determined from these spectra.

The resistivity of the active material coating portion is preferably at least 0.15 Ω·cm but not more than 12 Ω·cm. The resistivity of the active material coating portion can be obtained, for example, by calculation from the measured value of the powder resistance of the positive electrode active material.

The average particle size of groups of the positive electrode active material particles (namely, a powder of the positive electrode active material particles) (including the thickness of the active material coating portion in those cases where the particles includes an active material coating portion) is, for example, preferably within a range from 0.1 to 20.0 μm, and more preferably from 0.2 to 10.0 μm. In those cases where two or more types of positive electrode active material particles are used, the average particle size of each type of particles preferably falls within the above range.

In this description, the average particle size of groups of the positive electrode active material particles refers to the volume-based median diameter measured by a laser diffraction and light scattering method using a particle size distribution measurement device.

The binder contained in the positive electrode active material layer 12 is an organic substance, and examples include polyacrylic acid, lithium polyacrylate, polyvinylidene fluoride, polyvinylidene fluoride-hexafluoropropylene copolymers, styrene-butadiene rubber, polyvinyl alcohol, polyvinyl acetal, polyethylene oxide, polyethylene glycol, carboxymethyl cellulose, polyacrylonitrile and polyimide. A single type of binder may be used, or a combination of two or more types may be used.

The amount of the binder in the positive electrode active material layer 12 relative to the total mass of the positive electrode active material layer 12 is, for example, preferably not more than 1.5% by mass, and more preferably 1.0% by mass or less. Provided the amount of the binder is not more than the above upper limit, the proportion of matter in the positive electrode active material layer 12 that does not contribute to lithium ion conduction can be kept low, the true density of the positive electrode active material layer 12 can be increased, the proportion of the binder coating the surface of the positive electrode 1 is reduced, and the lithium conductivity can be further improved, enabling a further improvement in the high rate cycle characteristics.

In those cases where the positive electrode active material layer 12 contains a binder, the lower limit for the amount of the binder, relative to the total mass of the positive electrode active material layer 12, is preferably at least 0.1% by mass, and more preferably 0.5% by mass or greater.

Examples of the conductive assistant included in the positive electrode active material layer 12 include carbon materials such as graphite, graphene, hard carbon, Ketjen black, acetylene black, and carbon nanotubes. A single type of conductive assistant may be used, or a combination of two or more types may be used.

The amount of the conductive assistant in the positive electrode active material layer 12 relative to the total mass of the positive electrode active material layer 12 is, for example, preferably not more than 2% by mass, more preferably not more than 1% by mass, even more preferably 0.5% by mass or less, and most preferably 0% by mass (namely, no conductive assistant), with a state in which no independent conductive assistant particles (for example, independent carbon particles) are present being particularly desirable. Provided the amount of the conductive assistant is not more than the above upper limit, the proportion of matter in the positive electrode active material layer 12 that does not contribute to lithium ion conduction can be kept low, the true density of the positive electrode active material layer 12 can be increased, and a further improvement in the high rate cycle characteristics can be achieved.

In those cases where the positive electrode active material layer 12 contains a conductive assistant, the lower limit for the amount of the conductive assistant may be determined as appropriate in accordance with the type of conductive assistant, but for example, is typically greater than 0.1% by mass relative to the total mass of the positive electrode active material layer 12.

The expression that the positive electrode active material layer 12 “contains no conductive assistant” means the layer contains essentially no conductive assistant, but does not preclude the case where the layer contains a small amount that does not impair the effects of the present invention. For example, provided the amount of the conductive assistant relative to the total mass of the positive electrode active material layer 12 is 0.1% by mass or less, the layer may be deemed to contain no conductive assistant.

Conductive assistant particles that do not contribute to the conduction path may act as the source of battery self-discharge or undesirable side reactions.

### [Positive Electrode Current Collector]

The current collector main body 14 is composed of a metal material. Examples of the metal material include metals having conductivity such as copper, aluminum, titanium, nickel, and stainless steel.

The thickness of the current collector main body 14 is, for example, preferably within a range from 8 μm to 40 μm, and more preferably from 10 μm to 25 μm.

The thickness of the current collector main body 14 and the thickness of the positive electrode current collector 11 can be measured using a micrometer. One example of such as measurement device is a product MDH-25M manufactured by Mitutoyo Corporation.

### [Current Collector Coating Layer]

The current collector coating layers 15 contain a conductive material. The presence of the current collector coating layers 15 containing a conductive material enable the abovementioned voltage difference V1-V2 to be adjusted to a value within the appropriate range.

The conductive material in the current collector coating layer 15 preferably contains carbon (namely, conductive carbon), and a conductive material composed solely of carbon is particularly preferred. By including a conductive material in the current collector coating layer 15, the voltage difference V1-V2 can be adjusted to a value within the appropriate range.

The proportion of the conductive material in the current collector coating layer relative to the total mass of the current collector coating layer is preferably within a range from 80 to 99% by mass, and more preferably from 90 to 98% by mass.

The current collector coating layer 15 is, for example, preferably a coating layer that contains carbon particles such as carbon black and a binder. Examples of the binder of the current collector coating layer 15 include the same materials as those described above for the binder of the positive electrode active material layer 12.

The positive electrode current collector 11 in which the surfaces of the current collector main body 14 are coated with the current collector coating layers 15 can be produced, for example, by applying a slurry containing the conductive material, the binder and a solvent to the surfaces of the current collector main body 14 using a conventional coating method such as a gravure method, and then drying the slurry to remove the solvent.

The thickness of the current collector coating layer 15 is preferably within a range from 0.1 to 4.0 μm, and more preferably from 0.5 to 2.0 μm.

The thickness of the current collector coating layer 15 can be measured by measuring the thickness of the coating layer in an electron microscope (for example, SEM or TEM) image of a cross-section of the current collector coating layer. The thickness of the current collector coating layer 15 need not be uniform. It is preferable that a current collector coating layer 15 with a thickness of at least 0.1 μm is present on at least a portion of the surface of the current collector main body 14, and the maximum value for the thickness of the current collector coating layer 15 is preferably not more than 4.0 μm.

### [Method for Producing Positive Electrode]

The positive electrode 1 of the present embodiment can be produced, for example, using a method in which a composition for producing the positive electrode, containing the positive electrode active material, the binder and a solvent is applied to the positive electrode current collector 11, and the composition for producing the positive electrode is then dried to remove the solvent, thereby forming the positive electrode active material layer 12 on the positive electrode current collector 11 (also referred to as the active material layer formation step). The amount of conductive assistant in the composition for producing the positive electrode, expressed relative to the total mass of the solid fraction of the composition for producing the positive electrode, is typically not more than 2% by mass, preferably not more than 1% by mass, more preferably not more than 0.5% by mass, and particularly preferably 0% by mass (meaning the composition contains no conductive assistant).

By sandwiching the laminate composed of the positive electrode active material layer 12 formed on the positive electrode current collector 11 between two flat jigs, and then applying a uniform pressure in the thickness direction, the thickness of the positive electrode active material layer 12 can be adjusted. For example, a method in which pressure is applied using a roll press may be used.

The solvent of the composition for producing the positive electrode is preferably a nonaqueous solvent. Examples of the solvent include alcohols such as methanol, ethanol, 1-propanol and 2-propanol, chain-like or cyclic amides such as N-methylpyrrolidone and N,N-dimethylformamide, and ketones such as acetone. A single type of solvent may be used, or a combination of two or more types may be used.

The positive electrode active material layer 12 may contain a dispersant. Examples of the dispersant include polyvinylpyrrolidone (PVP), and One Shot Varnish (manufactured by ToyoColor Co., Ltd.).

In those cases where at least one of the conductive material and the conductive assistant used in coating the positive electrode active material contains carbon, the amount of conductive carbon, relative to the residual mass of the positive electrode 1 excluding the positive electrode current collector main body 14, is preferably within a range from 0.5 to 3.5% by mass, and more preferably from 1.5 to 3.0% by mass.

In those cases where the positive electrode 1 is composed of the positive electrode current collector main body 14 and the positive electrode active material layer 12, the residual mass of the positive electrode 1 excluding the positive electrode current collector main body 14 refers to the mass of the positive electrode active material layer 12.

In those cases where the positive electrode 1 is composed of the positive electrode current collector main body 14, the current collector coating layer 15 and the positive electrode active material layer 12, the residual mass of the positive electrode 1 excluding the positive electrode current collector main body 14 refers to the combined mass of the current collector coating layer 15 and the positive electrode active material layer 12.

Provided the amount of conductive carbon relative to the total mass of the positive electrode active material layer 12 falls within the above range, the battery capacity can be further improved, and a nonaqueous electrolyte secondary battery having excellent cycle characteristics can be achieved.

The amount of conductive carbon relative to the residual mass of the positive electrode 1 excluding the positive electrode current collector main body 14 can be measured by the <<Method for Measuring Conductive Carbon Content>> described below, using a dried product (powder) obtained by removing the entire layer from the positive electrode current collector main body 14 and drying this detached layer under vacuum at 120° C. as the measurement target object.

This amount of conductive carbon measured using the <<Method for Measuring Conductive Carbon Content>> described below includes the carbon in the active material coating portion, the carbon in the conductive assistant, and the carbon in the current collector coating layer 15. Carbon in the binder is not included.

The method described below can be used as the method for obtaining the measurement target object described above.

First, a piece of the positive electrode 1 of the desired size is punched out and immersed in a solvent (for example, N-methylpyrrolidone) and stirred to completely remove all layers (powder) present on the positive electrode current collector main body 14. Subsequently, once confirmation is made that no powder remains adhered to the positive electrode current collector main body 14, the positive electrode current collector main body 14 is removed from the solvent, yielding a suspension (slurry) containing the detached powder and the solvent. The obtained suspension is then dried at 120° C. to completely volatilize the solvent, yielding the desired measurement target object (powder).

### <<Method for Measuring Conductive Carbon Content>>

### [Measurement Method A]

The measurement target object is mixed uniformly, a sample of mass w1 is weighed, and a thermogravimetric differential thermal analysis is conducted in accordance with the procedure of step A1 and step A2 described below, yielding a TG curve. A first weight loss M1 (units: % by mass) and a second weight loss M2 (units: % by mass) are determined from the obtained TG curve. The conductive carbon content (units: % by mass) is obtained by subtracting M1 from M2.

Step A1: By measuring the mass w2 when the sample is heated in an argon gas stream flowing at 300 mL/minute, and the temperature is raised from 30° C. to 600° C. at a rate of temperature increase of 10° C./minute and then held at 600° C. for 10 minutes, the first weight loss M1 is able to be determined using formula (a1) shown below.

$$M 1 = ( w 1 - w 2 ) / w 1 \times 100 \qquad ( a1 )$$

Step A2: Immediately following the step A1, by cooling the sample from 600° C. at a rate of temperature decrease of 10° C./minute, holding the temperature at 200° C. for 10 minutes, completely changing the measurement gas from argon to oxygen, and subsequently measuring the mass w3 when the sample is heated in an oxygen gas stream flowing at 100 mL/minute, with the temperature raised from 200° C. to 1,000° C. at a rate of temperature increase of 10° C./minute and then held at 1,000° C. for 10 minutes, the second weight loss M2 (units: % by mass) is able to be determined using formula (a2) shown below.

$$M 2 = ( w 1 - w 3 ) / w 1 \times 100 \qquad ( a2 )$$

### [Measurement Method B]

The measurement target object is mixed uniformly, a sample of 0.0001 mg is weighed, the sample is then combusted under the combustion conditions described below, the generated carbon dioxide is quantified using a CHN elemental analyzer, and the total amount of carbon M3 (units: % by mass) contained in the sample is measured. Further, the first weight loss M1 is determined using the procedure described above in step A1 of the measurement method A. M1 is then subtracted from M3 to obtain the amount of conductive carbon (units: % by mass).

### [Combustion Conditions]

Furnace temperature: 1,150° C.
Reducing Furnace: 850° C.
Helium flow rate: 200 mL/minute
Oxygen flow rate: 25 to 30 mL/minute

### [Measurement Method C]

In a similar manner to that described above in measurement method B, the total amount of carbon M3 (units: % by mass) contained in the sample is measured. Further, using the method described below, the amount of binder-derived carbon M4 (units: % by mass) is also determined. The amount of conductive carbon (units: % by mass) is then obtained by subtracting M4 from M3.

In those cases where the binder is polyvinylidene fluoride (PVDF: molecular weight of monomer (CH₂CF₂): 64), calculations can be conducted using the formulas described below, using the amount of fluoride ions (F) (units: % by mass) measured by combustion ion chromatography using the tubular combustion method, the atomic weight (19) of the fluorine atoms of the monomer that forms the PVDF, and the atomic weight (12) of the carbon that constitutes the PVDF.

$$Amount of PVDF ( \% by mass ) = amount of fluoride ions ( units : \% by mass ) \times 64 / 38$$

$$Amount of PVDF - derived carbon M 4 ( units : \% by mass ) = amount of fluoride ions ( units : \% by mass ) \times 12 / 19$$

The fact that the binder is polyvinylidene fluoride can be confirmed by measuring the Fourier transform infrared spectrum of either the sample or a liquid prepared by extracting the sample into N,N-dimethylformamide solvent, and then confirming the absorption attributable to the C—F bonds. Confirmation can also be made by fluorine nuclear magnetic resonance spectroscopy (¹⁹F-NMR).

In those cases where the binder is identified as a material other than PVDF, the amount of binder-derived carbon M4 can be calculated by determining the amount of binder (units: % by mass) corresponding with that molecular weight and the amount of carbon (units: % by mass).

These techniques are described in the plurality of public documents listed below.

Toray Research Center: The TRC News No. 117 (September 2013), pp. 34 to 37 [searched: Feb. 10, 2021], internet URL <https://www.toray-research.co.jp/technical-info/trcnews/pdf/TRC117 (34-37).pdf>

Tosoh Analysis & Research Center: Technical Report No. T1019 2017.09.20 [searched: Feb. 10, 2021], internet URL <http://www.tosoh-arc.co.jp/techrepo/files/tarc00522/T1719N.pdf>

### <<Method for Analyzing Conductive Carbon>>

The conductive carbon that constitutes the active material coating portion of the positive electrode active material, and the conductive carbon of the conductive assistant can be distinguished using the analysis methods described below.

For example, by analyzing the particles in the positive electrode active material layer using transmission electron microscope electron energy loss spectroscopy (TEM-EELS), particles having a peak attributable to carbon in the vicinity of 290 eV only near the particle surface can be identified as the coated particles of the positive electrode active material particles, whereas particles having a peak attributable to carbon through to the particle interior can be identified as particles of the conductive assistant. Here, the expression “near the particle surface” means the region from the particle surface to a depth of, for example, 100 nm, whereas the expression “particle interior” means the region inside this region near the particle surface.

In another method, by subjecting the particles in the positive electrode active material layer to a mapping analysis by Raman spectroscopy, particles for which the G-band and D-band attributable to carbon, and a peak attributable to oxide crystals derived from the positive electrode active material are all observed simultaneously can be identified as the coated particles of the positive electrode active material particles, whereas particles for which only the G-band and the D-band are observed can be identified as particles of the conductive assistant. Trace amounts of carbon that are thought of as impurities, and trace amounts of carbon that have unintentionally detached from the surface of the positive electrode active material during production are not identified as the conductive assistant.

By using these methods, confirmation can be made as to whether or not a conductive assistant composed of a carbon material is contained within the positive electrode active material layer.

### [Negative Electrode]

The negative electrode active material layer 22 contains a negative electrode active material. The layer may also contain a binder. Further, the layer may also contain a conductive assistant. The negative electrode active material is preferably in particle form.

The negative electrode 20 can be produced, for example, by preparing a composition for producing the negative electrode, containing the negative electrode active material, the binder and a solvent, applying this composition to the negative electrode current collector 21, and then drying the composition to remove the solvent, thereby forming the negative electrode active material layer 22. The composition for producing the negative electrode may also contain a conductive assistant.

Examples of the negative electrode active material and the conductive assistant include carbon materials such as graphite, graphene, hard carbon, Ketjen black, acetylene black, and carbon nanotubes. A single type of each of the negative electrode active material and conductive assistant may be used, or a combination of two or more types of each material may be used.

Provided the negative electrode active material is as described above, the negative electrode active material layer 22 has a lower impedance than the positive electrode active material layer 12, meaning the negative electrode active material does not influence the effects of the present invention. However, in those cases where high resistance components are used, such as the case where a silicon negative electrode active material is used, it is preferable that the resistance is minimized by optimizing the particle size of the negative electrode active material and the amount of conductive assistant used, so that the resistance of the negative electrode active material layer 22 is lower than the resistance of the positive electrode active material layer 12.

Examples of the material of the negative electrode current collector 21, and the binder and solvent in the composition for producing the negative electrode include the same material as those described above for the material of the positive electrode current collector 11, and the binder and solvent in the composition for producing the positive electrode. The binder and solvent in the composition for producing the negative electrode may each be either a single type of material or a combination of two or more types.

The combined mass of the negative electrode active material and the conductive assistant, relative to the total mass of the negative electrode active material layer 22, is preferably within a range from 80.0% by mass to 99.9% by mass, and more preferably from 85.0% by mass to 98.0% by mass.

### [Separator]

The separator 30 is disposed between the negative electrode 20 and the positive electrode 10, and prevents short circuits and the like. The separator 30 may support the nonaqueous electrolyte described below.

There are no particular limitations on the separator 30, and examples include porous polymer membranes, nonwoven fabrics, and glass fibers and the like.

An insulation layer may be provided on one surface or both surfaces of the separator 30. This insulation layer is preferably a layer with a porous structure having insulating microparticles fixed to the layer with an insulation layer binder.

The separator 30 may contain at least one of various plasticizers, antioxidants and flame retardants.

Examples of the antioxidants include phenol-based antioxidants such as hindered phenol-based antioxidants, monophenol-based antioxidants, bisphenol-based antioxidants and polyphenol-based antioxidants, hindered amine-base antioxidants, phosphorus-based antioxidants, sulfur-based antioxidants, benzotriazole-based antioxidants, benzophenone-based antioxidants, triazine-based antioxidant, and salicylate ester-based antioxidants. The antioxidant is preferably a phenol-based antioxidant or a phosphorus-based antioxidant.

### [Nonaqueous Electrolyte]

The nonaqueous electrolyte is used to fill the space between the positive electrode 10 and the negative electrode 20. For example, a conventional nonaqueous electrolyte typically used in a lithium ion secondary battery or electric double layer capacitor or the like may be used.

A nonaqueous electrolyte produced by dissolving an electrolyte salt in an organic solvent is preferred as the nonaqueous electrolyte.

The organic solvent is preferably a solvent that has favorable resistance to high voltages. Examples of such solvents include polar solvents such as ethylene carbonate, propylene carbonate, dimethyl carbonate, γ-butyrolactone, sulfolane, dimethyl sulfoxide, acetonitrile, dimethylformamide, dimethylacetamide, 1,2-dimethoxyethane, 1,2-diethoxyethane, tetrahydrofuran, 2-methyltetrahydrofuran, dioxolane, and methyl acetate, as well as mixtures containing two or more of these polar solvents.

There are no particular limitations on the electrolyte salt, and examples include salts containing lithium such as LiPF₆, LiClO₄, LiBF₄, LiAsF₆, LiCF₃ CO₂, LiPF₆SO₃, LiN(SO₂F)₂, LiN(SO₂CF₃)₂, Li(SO₂CF₂CF₃)₂, LiN(COCF₃)₂ and LiN(COCF₂CF₃)₂, as well as mixtures containing two or more of these salts.

The nonaqueous electrolyte preferably contains a lithium imide salt, and more preferably contains a lithium imide salt represented by formula (1) shown below.

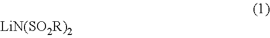

[wherein R represents a fluorine atom or CₓF₍₂ₓ₊₁₎, and x represents an integer of 1 to 3.]

Examples of the lithium imide salt represented by formula (1) include lithium bis(fluorosulfonyl)imide (LiFSI) and lithium bis(trifluoromethanesulfonyl)imide (LiN(SO₂CF₃)₂, hereinafter also abbreviated as LiTFSI).

The amount of the lithium imide salt in the nonaqueous electrolyte, expressed relative to the total mass of the nonaqueous electrolyte, is preferably at least 10% by mass but not more than 60% by mass, more preferably at least 20% by mass but not more than 50% by mass, and even more preferably at least 30% by mass but not more than 40% by mass. Provided the amount of the lithium imide salt is at least as large as the above lower limit, the cycle characteristics of the nonaqueous electrolyte secondary battery can be improved. Provided the amount of the lithium imide salt is not more than the above upper limit, the viscosity of the electrolyte can be lowered, and the charge/discharge characteristics when used at low temperature or under a large current can be improved.

The nonaqueous electrolyte secondary battery of the present embodiment can be used as a lithium ion secondary battery in all manner of applications, including industrial applications, consumer applications, vehicle applications, and household applications.

There are no particular limitations on the usage form of the nonaqueous electrolyte secondary battery of the present embodiment. For example, the battery can be used in a battery module containing a plurality of nonaqueous electrolyte secondary batteries connected together in series or parallel, or in a battery pack containing a plurality of battery modules and a battery control system connected together electrically, or a battery system containing a plurality of battery modules and a battery control system connected together electrically.

By using the present embodiment, increases in the resistance following charge/discharge cycles can be suppressed, and a nonaqueous electrolyte secondary battery having excellent cycle characteristics can be obtained. In other words, the nonaqueous electrolyte secondary battery of the present embodiment suffers little resistance change and exhibits little voltage change in the charge/discharge curve even when charge/discharge cycles are repeated at 3 C. Generally, when a charge/discharge pack and battery system are designed, changes in the resistance and the voltage of the nonaqueous electrolyte secondary battery are taken into consideration, and the input/output current is changed in accordance with the state of battery degradation. In contrast, the nonaqueous electrolyte secondary battery of the present embodiment suffers little resistance change or voltage change, making it simpler to design a battery system.

Moreover, with a typical nonaqueous electrolyte secondary battery, in applications where a large current is output, such as batteries for electric vehicles, hybrid vehicles, and idling stop systems, deterioration in the output characteristics limit the usage environments and necessitate battery exchanges. The nonaqueous electrolyte secondary battery of the present embodiment is expected to render these types of countermeasures unnecessary.

Similarly, in a battery module or batter pack containing a plurality of typical nonaqueous electrolyte secondary batteries connected together, because the change in resistance is large when charge/discharge cycles are repeated from the initial state, the closed circuit voltage in the initial state differs significantly from the closed circuit voltage following charge/discharge cycles. As a result, when discharge is conducted at the same C rate, the residual capacity of the batteries when the same closed circuit voltage is reached differs considerably, meaning the SOC estimation accuracy in a closed circuit state is poor. By using the present embodiment, any change in resistance and change in the closed circuit voltage is small, even after repeated charge/discharge cycles. Accordingly, an improvement in the SOC estimation accuracy during use can be expected.

### [Method for Producing Nonaqueous Electrolyte Secondary Battery]

The nonaqueous electrolyte secondary battery 1 can be produced, for example, by producing the positive electrode for the nonaqueous electrolyte secondary battery using the method for producing a nonaqueous electrolyte secondary battery positive electrode of the embodiment described above (also referred to as the nonaqueous electrolyte secondary battery positive electrode production step), and then disposing the nonaqueous electrolyte between the produced nonaqueous electrolyte secondary battery positive electrode 10 and the negative electrode 20 (also referred to as the nonaqueous electrolyte formation step).

### EXAMPLES

The present invention is described below in further detail using a series of examples and comparative examples, but the present invention is not limited to these examples.

### <Evaluation Methods>

### [High Rate Cycle Test, and Evaluation of Initial 3 C Discharge Capacity Rate]

Evaluation of the capacity retention rate was conducted by following the procedures (1) to (7) described below.
(1) A nonaqueous electrolyte secondary battery (cell) was produced with a rate capacity of 20 Ah, and a cycle evaluation was conducted at normal temperature (25° C.).
(2) The obtained cell was charged to an end voltage of 3.6 V at a 0.2 C rate (namely, 4 A) constant current, and charging was then conducted at a constant voltage with a current 1/10th of the above charging current deemed the end current (namely, 0.4 A).
(3) Discharging to rate the capacity was conducted at a constant current at a 0.2 C rate to an end voltage of 2.5 V. The discharge capacity at this time was deemed the reference capacity, and the reference capacity was deemed the 1 C rate current value (namely, 20 A).
(4) The cell was charged at a constant current at a 3 C rate (namely, 60 A) to an end voltage of 3.5 to 3.8 V (the specific voltage is listed for each example), and after resting for 10 seconds, the cell was discharged from this state at a 3 C rate to an end voltage of 2.5 V, and then left to rest for 10 seconds.
(5) The cycle test of (4) above was repeated 1,000 times. The discharge capacity during the first cycle was deemed the initial 3 C discharge capacity, and by dividing this value by the reference capacity, the initial 3 C discharge capacity rate was determined. Further, a discharge curve was obtained by plotting the voltage along the vertical axis and the cell state of charge (SOC) along the horizontal axis during the first cycle, with the state of charge normalized to SOC 100% at the start of discharge, and the voltage V1 was measured at SOC 50%. In a similar manner, the voltage V2 at SOC 50% during the 1,000th cycle was also measured.
(6) Charging was conducted in the same manner as (2) above, and the capacity was then confirmed in the same manner as (3) above.
(7) The confirmed discharge capacity measured in (6) was divided by the reference capacity prior to cycle testing and converted to a percentage to determine the capacity retention rate following 1,000 cycles (the 1,000 cycle capacity retention rate, units: %).

### [Evaluation of Internal Resistance Rate of Increase]

Evaluation of the internal resistance rate of increase was conducted by following the procedure described below.

Between procedures (3) and (4) of the above high rate cycle test, the 0.1 Hz AC resistance (units: mΩ) of the nonaqueous electrolyte secondary battery was measured, and this value was deemed the initial state resistance R1.

After procedure (6) of the above high rate cycle test, the 0.1 Hz AC resistance (units: mΩ) was once again measured, and this value was deemed the post cycle test resistance R2. The obtained R2 value was divided by R1 to determine the internal resistance rate of increase (%).

One example of an AC resistance measurement device (impedance analyzer) that may be used is a model SP-50ez manufactured by BioLogic Co., Ltd.

### Production Example: Production of Negative Electrode

First, 100 parts by mass of artificial graphite as a negative electrode active material, 1.5 parts by mass of styrene-butadiene rubber as a binder, 1.5 parts by mass of sodium carboxymethyl cellulose as a thickener, and water as a solvent were mixed together to obtain a negative electrode production composition with a solid fraction of 50% by mass.

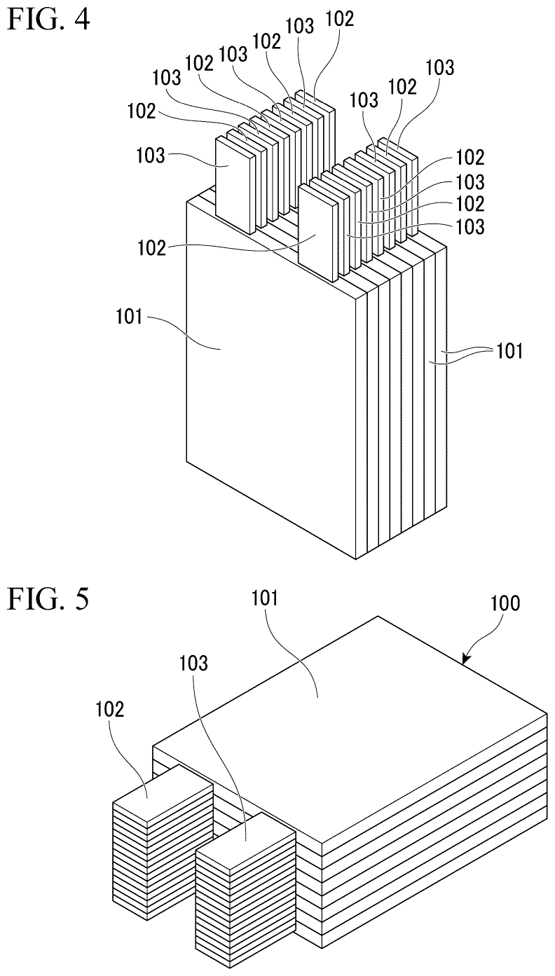

The thus obtained composition for producing a negative electrode was applied to both surfaces of a copper foil (thickness: 8 μm) and then vacuum dried at 100° C., and the resulting laminate was pressed under a load of 2 kN to obtain a negative electrode sheet. The obtained negative electrode sheet was punched out into an electrode shape, thus obtaining a negative electrode.

<Method for Producing Module having Eight Nonaqueous Electrolyte Secondary Batteries Connected in Series>
(1) Eight new cells with a rated capacity of 20 Ah were produced separately from the nonaqueous electrolyte secondary battery (cell) used in the high rate cycle test and the evaluation of the internal resistance rate of increase. Nonaqueous electrolyte secondary batteries (cells) 101 such as those illustrated in FIG. 3 were prepared in the same manner as the cell used in the high rate cycle test and the evaluation of the internal resistance rate of increase. Each nonaqueous electrolyte secondary battery (cell) 101 has a positive electrode tab 102 and a negative electrode tab 103.
(2) Each of the produced eight nonaqueous electrolyte secondary batteries (cells) 101 was subjected to CC discharge at a 0.2 C rate (namely, 4 A) until the cell voltage reached 2.5 V.
(3) As illustrated in FIG. 4, the eight nonaqueous electrolyte secondary batteries (cells) 101 were stacked and bonded together using a double-sided tape so that when viewed across the thickness direction of the nonaqueous electrolyte secondary batteries (cells) 101, the positive electrode tabs 102 and negative electrode tabs 103 were disposed in an alternating arrangement.
(4) As illustrated in FIG. 5, the positive electrode tabs 102 and negative electrode tabs 103 were then laser welded to connect the eight cells in series, yielding a 20 Ah nonaqueous electrolyte secondary battery module 110.
   <Evaluation Method for Module having Eight Nonaqueous Electrolyte Secondary Batteries Connected in Series>
(1) The positive electrode tab 102 and negative electrode tab 103 positioned at the end of the 20 Ah nonaqueous electrolyte secondary battery module 110 produced in the manner described above, namely the eight series-connected positive electrodes and negative electrodes, were connected to a charge/discharge apparatus, the module was then placed in a thermostatic chamber in a 25° C. environment and left in standby mode for one hour to allow the entire module to reach a uniform temperature, and a cycle evaluation was then conducted.
(2) Following constant current charging at a 0.2 C rate (namely, 4 A) to an end voltage of 28.8 V, charging was then conducted at a constant voltage with a current 1/10th of the above charging current deemed the end current (namely, 0.4 A).
(3) Discharging to confirm the capacity was conducted at a constant current at a 0.2 C rate to an end voltage of 20.0 V. The discharge capacity at this time was deemed the reference capacity, and the reference capacity was deemed the 1 C rate current value (namely, 20 A).
(4) The module was charged at a constant current at a 3 C rate (namely, 60 A) with the end voltage set to a value 8 times the single cell voltage described above in the high rate cycle test, and after resting for 10 seconds, the module was discharged from this state at a 3 C rate to an end voltage of 20 V, and then left to rest for 10 seconds.
(5) The cycle test of (4) above was repeated 1,000 times. A discharge curve was obtained by plotting the voltage along the vertical axis and the cell state of charge (SOC) along the horizontal axis during the first cycle, with the state of charge normalized to SOC 100% at the start of discharge, and the voltage V3 was measured at SOC 50%. In a similar manner, a discharge curve was plotted for the 1,000th cycle, the SOC (%) when the voltage reached V3 was measured, and the SOC estimation difference and accuracy following the 1,000th cycle were evaluated.
(6) Charging was conducted in the same manner as (2) above, and the capacity was then confirmed in the same manner as (3) above.
(7) The confirmed discharge capacity measured in (6) was divided by the reference capacity prior to cycle testing and converted to a percentage to determine the capacity retention rate following 1,000 cycles (the 1,000 cycle capacity retention rate, units: %).

### Example 1

First, a positive electrode current collector was produced by using the method described below to coat both the top and rear surfaces of the positive electrode current collector main body with a current collector coating layer. An aluminum foil (thickness: 15 μm) was used as the positive electrode current collector main body.

Next, 100 parts by mass of carbon black, a binder, and pure water as a solvent medium were mixed together to obtain a slurry. The amount of pure water used was adjusted to the amount required to enable favorable application of the slurry.

The thus obtained slurry was applied to both surfaces of the positive electrode current collector main body by a gravure method, and was then dried to remove the solvent, thus forming a current collector coating layer and completing the positive electrode current collector.

Next, a positive electrode active material layer was formed using the method described below.

Lithium iron phosphate (LFP) as a positive electrode active material, a conductive carbon, a PVDF binder, and NMP as a solvent were mixed together using a mixer to obtain a composition for producing a positive electrode. The amount of conductive carbon relative to the total mass of the positive electrode active material layer, namely relative to the combined mass of LFP, PVDF and conductive carbon, was 1.5% by mass. The amount of solvent used was adjusted to the amount required to enable favorable application of the composition for producing a positive electrode.

The composition for producing a positive electrode was applied to both surfaces of the positive electrode current collector, and following preliminary drying, vacuum drying was conducted in an environment at 120° C., thus forming positive electrode active material layers. The obtained laminate was pressed with a load of 10 kN to obtain a positive electrode sheet. The positive electrode active material layers on the two surfaces were formed using the same coating amounts to form layers of uniform thickness.

The obtained positive electrode sheet was punched out into an electrode shape, thus obtaining a positive electrode.

Using the method described below, a nonaqueous electrolyte secondary battery of the structure illustrated in FIG. 1 was produced.

In a solvent prepared by mixing ethylene carbonate (EC) and ethyl methyl carbonate (EMC) in an EC: EMC volumetric ratio of 30:70, LiPF₆ was dissolved in a concentration of 1 mol/liter as an electrolyte, and LiFSI was then dissolved in a concentration of 0.4 mol/lite as a lithium imide salt, thus completing preparation of a nonaqueous electrolyte solution.

The positive electrode obtained in this example and negative electrodes obtained in Production Example 1 were stacked alternately with separators disposed therebetween to produce an electrode laminate having negative electrodes as the outermost layers. A polyolefin film (thickness: 15 μm) was used for the separators.

In this step for producing the electrode laminate, the separators and the positive electrode were first laminated together, and the negative electrodes were then laminated to the separators.

Terminal tabs were connected electrically to the positive electrode current collector exposed portion and the negative electrode current collector exposed portion of the electrode laminate, and the electrode laminate was sandwiched between aluminum laminate films and subjected to lamination processing to seal three sides of the laminate, with the terminal tabs protruding externally.

Subsequently, the nonaqueous electrolyte solution was injected from the remaining unsealed side, and the side was then subjected to vacuum sealing to complete production of a nonaqueous electrolyte secondary battery (laminated cell). The capacity of the nonaqueous electrolyte secondary battery was 1.0 Ah.

A high rate cycle test was conducted using the nonaqueous electrolyte secondary battery of Example 1. The end voltage for the constant current charging was set to 3.8 V, the initial 3 C discharge capacity rate was 98.1%, and the voltage difference V1-V2 between the voltage V1 in the first cycle and the voltage V2 in the 1,000th cycle was 3.5 mV. The results are shown in Table 2.

Based on the results in Table 2, it was evident that the nonaqueous electrolyte secondary battery of Example 1 had a 1,000 cycle capacity retention rate of 93%.

Further, an evaluation of the internal resistance rate of increase for the nonaqueous electrolyte secondary battery of Example 1 was also conducted. The result is shown in Table 2.

The result in Table 2 shows that the internal resistance rate of increase was 100.5%.

A high rate cycle test was also conducted using a battery module having eight of the nonaqueous electrolyte secondary batteries of Example 1 connected in series. With the end voltage for the constant current charging set to 30.4 V, the capacity retention rate after 1,000 cycles was 91%, and the SOC estimation difference was 2.19%.

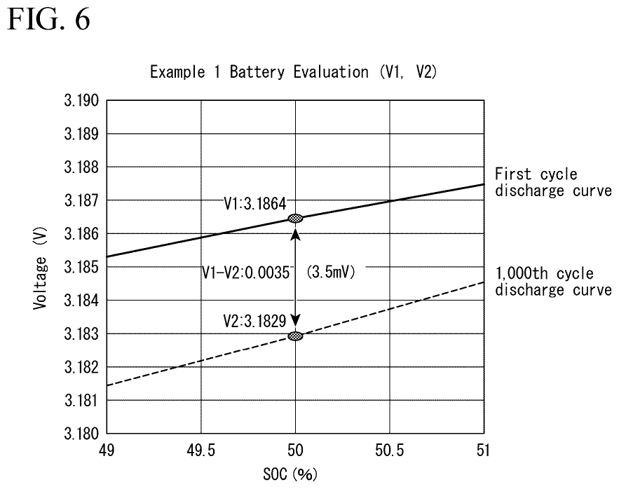

Further, FIG. 6 illustrates discharge curves representing the relationship between the voltage and the SOC for the first charge/discharge cycle and the 1,000th charge/discharge cycle of the nonaqueous electrolyte secondary battery.

As illustrated in FIG. 6, the state (degree of degradation) of the battery differs between the first cycle and the 1,000th cycle, and therefore at a battery state of charge of 50% (SOC 50%), the voltage also differs. The difference (voltage difference V1-V2) between the voltage V1 in the first cycle and the voltage V2 in the 1,000th cycle at a battery state of charge of 50% (SOC 50%) was evaluated.

A small value for the voltage difference V1-V2 indicates less change (degradation) in the battery state. In all of Examples 1 to 6, the value of the voltage difference V1-V2 was not more than 5.0 mV.

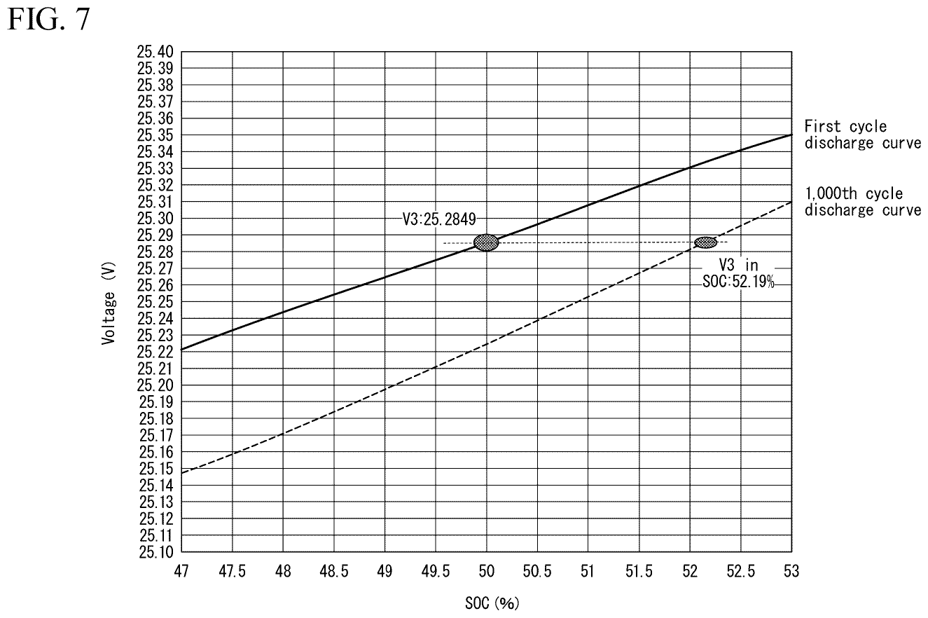

Furthermore, FIG. 7 illustrates discharge curves representing the relationship between the voltage and the SOC for the first charge/discharge cycle and the 1,000th charge/discharge cycle of the nonaqueous electrolyte secondary battery module.

As illustrated in FIG. 7, using the voltage V3 at SOC 50% on the discharge curve for the first cycle as a reference, the SOC on the discharge curve for the 1,000th cycle when the voltage V3 was reached was measured, enabling an evaluation of the SOC difference at the same voltage V3.

When discharge in the 1,000th cycle was conducted until the voltage V3 representing SOC 50% in the first cycle was obtained, the SOC value was 52.19%, meaning when the cell voltage during discharge was used to estimate SOC, the difference was only 2.19%. In all of Examples 1 to 6, this difference was not more than 2.5%, confirming that estimation of the residual capacity of the battery module could be conducted in the same manner as that used in the initial state.

### Example 2

A high rate cycle test was conducted for a nonaqueous electrolyte secondary battery of Example 2 having the same structure as the battery of Example 1. The end voltage for the constant current charging was set to 3.6 V, the initial 3 C discharge capacity rate was 97.4%, and the voltage difference V1-V2 between the voltage V1 in the first cycle and the voltage V2 in the 1,000th cycle was 2.5 mV. The results are shown in Table 2.

Based on the results in Table 2, it was evident that the nonaqueous electrolyte secondary battery of Example 2 had a 1,000 cycle capacity retention rate of 96%.

Further, an evaluation of the internal resistance rate of increase for the nonaqueous electrolyte secondary battery of Example 2 was also conducted. The result is shown in Table 2.

The result in Table 2 shows that the internal resistance rate of increase was 100.3%.

A high rate cycle test was also conducted using a battery module having eight of the nonaqueous electrolyte secondary batteries of Example 2 connected in series. With the end voltage for the constant current charging set to 28.8 V, the capacity retention rate after 1,000 cycles was 94%, and the SOC estimation difference was 2.12%.

### Example 3

A high rate cycle test was conducted for a nonaqueous electrolyte secondary battery of Example 3 having the same structure as the battery of Example 1. The end voltage for the constant current charging was set to 3.5 V, the initial 3 C discharge capacity rate was 88.3%, and the voltage difference V1-V2 between the voltage V1 in the first cycle and the voltage V2 in the 1,000th cycle was 1.7 mV. The results are shown in Table 2.

Based on the results in Table 2, it was evident that the nonaqueous electrolyte secondary battery of Example 3 had a 1,000 cycle capacity retention rate of 97%.

Further, an evaluation of the internal resistance rate of increase for the nonaqueous electrolyte secondary battery of Example 3 was also conducted. The result is shown in Table 2.

The result in Table 2 shows that the internal resistance rate of increase was 100.2%.

A high rate cycle test was also conducted using a battery module having eight of the nonaqueous electrolyte secondary batteries of Example 3 connected in series. With the end voltage for the constant current charging set to 28.0 V, the capacity retention rate after 1,000 cycles was 95%, and the SOC estimation difference was 2.09%.

### Example 4

With the exceptions of altering the amount of conductive carbon in the current collector coating layer to 2.5% by mass, and altering the amount of conductive carbon relative to the total mass of the positive electrode active material layer to 1.0% by mass, a positive electrode of Example 4 was produced in the same manner as that described for Example 1.

A high rate cycle test was conducted for the nonaqueous electrolyte secondary battery of Example 4. The end voltage for the constant current charging was set to 3.6 V, the initial 3 C discharge capacity rate was 97.6%, and the voltage difference V1-V2 between the voltage V1 in the first cycle and the voltage V2 in the 1,000th cycle was 4.3 mV. The results are shown in Table 2.

Based on the results in Table 2, it was evident that the nonaqueous electrolyte secondary battery of Example 4 had a 1,000 cycle capacity retention rate of 94%.

Further, an evaluation of the internal resistance rate of increase for the nonaqueous electrolyte secondary battery of Example 4 was also conducted. The result is shown in Table 2.

The result in Table 2 shows that the internal resistance rate of increase was 100.7%.

A high rate cycle test was also conducted using a battery module having eight of the nonaqueous electrolyte secondary batteries of Example 4 connected in series. With the end voltage for the constant current charging set to 28.8 V, the capacity retention rate after 1,000 cycles was 91%, and the SOC estimation difference was 2.39%.

### Example 5

With the exception of not including the lithium imide salt in the nonaqueous electrolyte solution, a positive electrode of Example 5 was produced in the same manner as that described for Example 1.

A high rate cycle test was conducted for the nonaqueous electrolyte secondary battery of Example 5. The end voltage for the constant current charging was set to 3.6 V, the initial 3 C discharge capacity rate was 93.4%, and the voltage difference V1-V2 between the voltage V1 in the first cycle and the voltage V2 in the 1,000th cycle was 4.8 mV. The results are shown in Table 2.

Based on the results in Table 2, it was evident that the nonaqueous electrolyte secondary battery of Example 5 had a 1,000 cycle capacity retention rate of 91%.

Further, an evaluation of the internal resistance rate of increase for the nonaqueous electrolyte secondary battery of Example 5 was also conducted. The result is shown in Table 2.

The result in Table 2 shows that the internal resistance rate of increase was 101.5%.

A high rate cycle test was also conducted using a battery module having eight of the nonaqueous electrolyte secondary batteries of Example 5 connected in series. With the end voltage for the constant current charging set to 28.8 V, the capacity retention rate after 1,000 cycles was 87%, and the SOC estimation difference was 2.44%.

### Example 6

A high rate cycle test was conducted for a nonaqueous electrolyte secondary battery of Example 6 having the same structure as the battery of Example 1. The end voltage for the constant current charging was set to 3.4 V, the initial 3 C discharge capacity rate was 52.2%, and the voltage difference V1-V2 between the voltage V1 in the first cycle and the voltage V2 in the 1.000th cycle was 0.7 mV. The results are shown in Table 2.

Based on the results in Table 2, it was evident that the nonaqueous electrolyte secondary battery of Example 6 had a 1,000 cycle capacity retention rate of 98%. Further, an evaluation of the internal resistance rate of increase for the nonaqueous electrolyte secondary battery of Example 6 was also conducted. The result is shown in Table 2.

The result in Table 2 shows that the internal resistance rate of increase was 100.1%.

A high rate cycle test was also conducted using a battery module having eight of the nonaqueous electrolyte secondary batteries of Example 6 connected in series. With the end voltage for the constant current charging set to 27.7 V, the capacity retention rate after 1,000 cycles was 95%, and the SOC estimation difference was 2.04%.

### Comparative Example 1

A high rate cycle test was conducted for a nonaqueous electrolyte secondary battery of Comparative Example 1 having the same structure as the battery of Example 1. The end voltage for the constant current charging was set to 4 V, the initial 3 C discharge capacity rate was 98.9%, and the voltage difference V1-V2 between the voltage V1 in the first cycle and the voltage V2 in the 1,000th cycle was 13.2 mV. The results are shown in Table 2.

Based on the results in Table 2, it was evident that the nonaqueous electrolyte secondary battery of Comparative Example 1 had a 1,000 cycle capacity retention rate of 91%.

Further, an evaluation of the internal resistance rate of increase for the nonaqueous electrolyte secondary battery of Comparative Example 1 was also conducted. The result is shown in Table 2.

The result in Table 2 shows that the internal resistance rate of increase was 105.8%.

A high rate cycle test was also conducted using a battery module having eight of the nonaqueous electrolyte secondary batteries of Comparative Example 1 connected in series. With the end voltage for the constant current charging set to 32.0 V, the capacity retention rate after 1,000 cycles was 87%, and the SOC estimation difference was 15.95%.

### Comparative Example 2

With the exceptions of not providing a current collector coating layer, and adjusting the amount of conductive carbon relative to the total mass of the positive electrode active material layer to 6.5% by mass by adding a conductive assistant, a positive electrode of Comparative Example 2 was produced in the same manner as that described for Example 1.

A high rate cycle test was conducted for the nonaqueous electrolyte secondary battery of Comparative Example 2. The end voltage for the constant current charging was set to 3.6 V, the initial 3 C discharge capacity rate was 81.0%, and the voltage difference V1-V2 between the voltage V1 in the first cycle and the voltage V2 in the 1,000th cycle was 94.1 mV. The results are shown in Table 2.

Based on the results in Table 2, it was evident that the nonaqueous electrolyte secondary battery of Comparative Example 2 had a 1,000 cycle capacity retention rate of 24%.

Further, an evaluation of the internal resistance rate of increase for the nonaqueous electrolyte secondary battery of Comparative Example 2 was also conducted. The result is shown in Table 2.

The result in Table 2 shows that the internal resistance rate of increase was 182.4%.

A high rate cycle test was also conducted using a battery module having eight of the nonaqueous electrolyte secondary batteries of Comparative Example 2 connected in series. With the end voltage for the constant current charging set to 28.8 V, the capacity retention rate after 1,000 cycles was 15%, and the SOC estimation difference was 20.40%.

### Comparative Example 3

With the exception of adjusting the amount of conductive carbon relative to the total mass of the positive electrode active material layer to 6.5% by mass by adding a conductive assistant, a positive electrode of Comparative Example 3 was produced in the same manner as that described for Example 1.

A high rate cycle test was conducted for the nonaqueous electrolyte secondary battery of Comparative Example 3. The end voltage for the constant current charging was set to 3.6 V, the initial 3 C discharge capacity rate was 97.8%, and the voltage difference V1-V2 between the voltage V1 in the first cycle and the voltage V2 in the 1,000th cycle was 8.5 mV. The results are shown in Table 2.

Based on the results in Table 2, it was evident that the nonaqueous electrolyte secondary battery of Comparative Example 3 had a 1,000 cycle capacity retention rate of 96%.

Further, an evaluation of the internal resistance rate of increase for the nonaqueous electrolyte secondary battery of Comparative Example 3 was also conducted. The result is shown in Table 2.

The result in Table 2 shows that the internal resistance rate of increase was 103.3%.

A high rate cycle test was also conducted using a battery module having eight of the nonaqueous electrolyte secondary batteries of Comparative Example 3 connected in series. With the end voltage for the constant current charging set to 28.8 V, the capacity retention rate after 1,000 cycles was 93%, and the SOC estimation difference was 11.53%.

### Comparative Example 4

With the exceptions of using nickel cobalt manganese oxide (NCM) as the positive electrode active material, and adjusting the amount of conductive carbon relative to the total mass of the positive electrode active material layer to 5.0% by mass by adding a conductive assistant, a positive electrode of Comparative Example 4 was produced in the same manner as that described for Example 1.

A high rate cycle test was conducted for the nonaqueous electrolyte secondary battery of Comparative Example 4. The end voltage for the constant current charging was set to 3.8 V, the initial 3 C discharge capacity rate was 11.2%, and the voltage difference V1-V2 between the voltage V1 in the first cycle and the voltage V2 in the 1,000th cycle was 123.6 mV. The results are shown in Table 2.

Based on the results in Table 2, it was evident that the nonaqueous electrolyte secondary battery of Comparative Example 4 had a 1,000 cycle capacity retention rate of 18%.

Further, an evaluation of the internal resistance rate of increase for the nonaqueous electrolyte secondary battery of Comparative Example 4 was also conducted. The result is shown in Table 2.

The result in Table 2 shows that the internal resistance rate of increase was 252.3%.

A high rate cycle test was also conducted using a battery module having eight of the nonaqueous electrolyte secondary batteries of Comparative Example 4 connected in series. With the end voltage for the constant current charging set to 30.4 V, the capacity retention rate after 1,000 cycles was 8%, and the SOC estimation difference was 41.76%.

TABLE 1

| | Positive electrode composition | | | | | Nonaqueous |
|---|---|---|---|---|---|---|
| | Current | | Active | | | electrolyte in |
| | collector | Active | material | Amount of | | electrolyte |
| | coating | material | coating | conductive | Conductive | solution |
| | layer | type | layer | carbon | assistant | Imide salt |
| | Units | | | | | |
| Item | — | — | — | % by mass | % by mass | mol/L |
| Example 1 | yes | LFP | yes | 1.5 | 0 | 0.4 |
| Example 2 | yes | LFP | yes | 1.5 | 0 | 0.4 |
| Example 3 | yes | LFP | yes | 1.5 | 0 | 0.4 |
| Example 4 | yes | LFP | yes | 2.5 | 1 | 0.4 |
| Example 5 | yes | LFP | yes | 1.5 | 0 | 0 |
| Example 6 | yes | LFP | yes | 1.5 | 0 | 0.4 |
| Comparative Example 1 | yes | LFP | yes | 1.5 | 0 | 0.4 |
| Comparative Example 2 | no | LFP | yes | 6.5 | 5 | 0.4 |
| Comparative Example 3 | yes | LFP | yes | 6.5 | 5 | 0.4 |
| Comparative Example 4 | yes | NCM | no | 5 | 5 | 0.4 |

TABLE 2

| | Evaluation results for single nonaqueous electrolyte secondary battery | | | | | | |
|---|---|---|---|---|---|---|---|
| | | | | | Initial | | |
| | | V 1 | V 2 | | 3 C discharge | | |
| | | (closed circuit | (closed circuit | | capacity rate | | |
| | | voltage at | voltage at | | (discharge capacity | Internal | |
| | | SOC 50% for | SOC 50% for | | for 1st 3.0 C cycle/ | resistance rate | Capacity |
| | Constant | 1st 3 C | 1,000th 3 C | | discharge capacity | of increase | retention rate |
| | charging end | discharge | discharge | | for initial 0.2 C | AC resistance | 1st cycle/ |
| | voltage | cycle) | cycle) | V 1-V 2 | cycle) | 0.1 Hz | 1,000th cycle |
| | Units | | | | | | |
| Item | V | V | V | mV | % | % | % |
| Example 1 | 3.8 | 3.1864 | 3.1829 | 3.5 | 98.1 | 100.5 | 93 |
| Example 2 | 3.6 | 3.1847 | 3.1822 | 2.5 | 97.4 | 100.3 | 96 |
| Example 3 | 3.5 | 3.181 | 3.1793 | 1.7 | 88.3 | 100.2 | 97 |
| Example 4 | 3.6 | 3.1851 | 3.1808 | 4.3 | 97.6 | 100.7 | 94 |
| Example 5 | 3.6 | 3.1831 | 3.1783 | 4.8 | 93.4 | 101.5 | 91 |
| Example 6 | 3.4 | 3.1803 | 3.1796 | 0.7 | 52.2 | 100.1 | 98 |
| Comparative | 4 | 3.1887 | 3.1755 | 13.2 | 98.9 | 105.8 | 91 |
| Example 1 | | | | | | | |
| Comparative | 3.6 | 3.1844 | 3.0903 | 94.1 | 81 | 182.4 | 24 |
| Example 2 | | | | | | | |
| Comparative | 3.6 | 3.1852 | 3.1767 | 8.5 | 97.8 | 103.3 | 96 |
| Example 3 | | | | | | | |
| Comparative | 3.8 | 2.9744 | 2.8508 | 123.6 | 11.2 | 252.3 | 18 |
| Example 4 | | | | | | | |

| | Evaluation results for module (battery pack) having eight | | | | |
|---|---|---|---|---|---|
| | nonaqueous electrolyte secondary batteries in series | | | | |
| | | | | | SOC difference |
| | | | | | between SOC |
| | | | | | 50% at V 3 in |
| | | | | | 1st cycle and |
| | | | | | SOC at V 3 during |
| | | | | | discharge at 3 C |
| | | | V 3 | | rate after 1,000 |
| | | | (closed circuit | | cycles (SOC |
| | | Capacity | voltage at | SOC at V 3 | estimation |
| | Constant | retention rate | SOC 50% for | during | difference |
| | charging end | 1st cycle/ | 1st 3 C rate | 1,000th 3 C | compared with |
| | voltage | 1,000th cycle | discharge) | rate discharge | initial state) |
| | Units | | | | |
| Item | V | % | V | % | Δ% |
| Example 1 | 30.4 | 91 | 25.2849 | 52.19 | 2.19 |
| Example 2 | 28.8 | 94 | 25.1176 | 52.12 | 2.12 |
| Example 3 | 28 | 95 | 25.0078 | 52.09 | 2.09 |
| Example 4 | 28.8 | 91 | 25.2407 | 52.39 | 2.39 |
| Example 5 | 28.8 | 87 | 25.0644 | 52.44 | 2.44 |
| Example 6 | 27.2 | 95 | 25.0983 | 52.04 | 2.04 |
| Comparative | 32 | 87 | 25.2807 | 65.95 | 15.95 |
| Example 1 | | | | | |
| Comparative | 28.8 | 15 | 25.0754 | 70.4 | 20.4 |
| Example 2 | | | | | |
| Comparative | 28.8 | 93 | 25.1816 | 61.53 | 11.53 |
| Example 3 | | | | | |
| Comparative | 30.4 | 8 | 23.4952 | 91.76 | 41.76 |
| Example 4 | | | | | |

In the evaluation results for the nonaqueous electrolyte secondary batteries and the evaluation results for the battery modules having eight nonaqueous electrolyte secondary batteries connected in series, the nonaqueous electrolyte secondary batteries of Examples 1 to 6 each exhibited a high initial 3 C discharge rate, a low rate of increase in the internal resistance following high rate cycles, a high capacity retention rate, and a value of V1-V2 representing the change in the discharge curve between the first cycle and the 1,000th cycle of 5 mV or less. Accordingly, in the high rate cycle test results for the battery modules having eight nonaqueous electrolyte secondary batteries connected in series, the SOC estimation difference following 1,000 cycles was small, and the results suggested that SOC estimation was possible by referring to the closed circuit voltage even after usage of the modules under harsh conditions.

In Examples 1 to 3, it is thought that by controlling the charging voltage per cell of the nonaqueous electrolyte secondary battery to a value within a range from 3.5 to 3.8 V, a low internal resistance rate of increase and a high capacity retention rate were able to be achieved.

In Example 4, although a structure was used in which the positive electrode active material layer contained 1.0% by mass of a conductive assistant, favorable results were able to be obtained.

In Example 5, although an imide salt was not dissolved in the electrolyte solution, favorable results were able to be obtained.

In Example 6, the constant current charging end voltage was reduced to 3.4 V, and the initial 3 C discharge capacity rate decreased, and the charge/discharge capacity achievable in the high rate cycle compared with the 0.2 C reference capacity decreased to 52.2%.

In Comparative Example 1, increasing the constant current charging end voltage to 4.0 V increased the initial 3 C discharge capacity rate to 98.9%, but the rate of increase of the internal resistance also increased to 105.8%, and the value of V1-V2 increased to 13.2 mV. Accordingly, in the evaluation of the battery module having eight nonaqueous electrolyte secondary batteries connected in series, the 1,000th cycle SOC estimation difference at V3 increased to 15.95%, a result that means SOC estimation following use is difficult.

Comparative Example 2 was a structure that lacked a current collector coating layer and included 5.0% by mass of a conductive assistant in the positive electrode active material layer, and it is thought that during the high rate cycles, degradation and the like of the electrolyte at the highly reactive current collector surface occurred, causing an increase in the internal resistance rate of increase to 182.4%, and an increase in the value of V1-V2 to 94.1 mV. The capacity retention rate after 1,000 cycles was 24%, confirming a marked level of degradation. In the evaluation of the battery module having eight nonaqueous electrolyte secondary batteries connected in series, the capacity retention rate after 1,000 cycles was 15%, a further decreases from the result for the single nonaqueous electrolyte secondary battery. It is thought that this is because the structure of the battery module means that the heat generated due to resistance dissipates less easily than a single nonaqueous electrolyte secondary battery, causing increased thermal degradation. The 1,000th cycle SOC estimation difference at V3 increased to 20.40%, a result that means SOC estimation following use is difficult.

Comparative Example 3 differed from Comparative Example 1 only in the use of the current collector coating layer, but the rate of increase in the resistance was a high value of 103.3%, and V1-V2 was also a large 8.5 mV. It is surmised that by including a large amount of the conductive assistant in the positive electrode active material layer, side reactions with the electrolyte solution tended to occur in the vicinity of the conductive assistant during the high rate cycles, resulting in a larger increase in the resistance when compared with the examples. The 1,000th cycle SOC estimation difference at V3 also increased to 11.53%, a result that means SOC estimation following use is difficult.

Comparative Example 4 was a structure that used NCM as the positive electrode active material, and because the resistance of the active material itself was high, the initial 3 C discharge capacity rate was low, and degradation caused by the active material during the high rate cycles was also confirmed. Unlike LFP, NCM is a crystal with a layered rock salt structure, and it is thought that insertion and extraction of lithium ions at a high rate tends to cause a breakdown of the structure, causing degradation, resulting in the high value of 252.3% for the resistance rate of increase and the large V1-V2 value of 123.6 mV. Furthermore, the capacity retention rate after 1,000 cycles was 18%, confirming marked degradation. In the evaluation of the battery module having eight nonaqueous electrolyte secondary batteries connected in series, in a similar manner to Comparative Example 1, it is thought that producing the module caused additional degradation due to resistance heat generation, and the capacity retention rate fell to 8%. The 1,000th cycle SOC estimation difference at V3 increased to 41.76%, a result that means SOC estimation following use is difficult.

### INDUSTRIAL APPLICABILITY

The present invention is able to provide a nonaqueous electrolyte secondary battery which exhibits excellent cycle characteristics and in which any increase in the resistance following charge/discharge cycles is suppressed, and can also provide a battery module and a battery system which contain the nonaqueous electrolyte secondary battery, and provide superior estimation accuracy relating to residual capacity following charge/discharge cycles.

### REFERENCE SIGNS LIST

1 Nonaqueous electrolyte secondary battery
10 Positive electrode
11 Positive electrode current collector
12 Positive electrode active material layer
13 Positive electrode current collector exposed portion
14 Positive electrode current collector main body
15 Current collector coating layer
20 Negative electrode
21 Negative electrode current collector
22 Negative electrode active material layer
23 Negative electrode current collector exposed portion
30 Separator
40 External case
101 Nonaqueous electrolyte secondary battery (cell)
102 Positive electrode tab
103 Negative electrode tab
110 Nonaqueous electrolyte secondary battery module

1. A nonaqueous electrolyte secondary battery comprising a positive electrode, a negative electrode, and a nonaqueous electrolyte present between the positive electrode and the negative electrode, wherein
the positive electrode includes a current collector, and a positive electrode active material layer containing at least one type of positive electrode active material particles present on one surface or both surfaces of the current collector, and
when 1,000 cycles of constant current charging to an end voltage of not more than 3.8 V and constant current discharging to an end voltage of 2.5 V are repeated at a 3 C rate current, at a point of a state of charge (SOC) of 50% on a discharge curve plotted with voltage along a vertical axis and cell SOC along a horizontal axis, a voltage difference V1-V2 between a voltage V1 of a first cycle and a voltage V2 of a 1,000th cycle is at least 0.1 mV but not more than 5.0 m V.

2. The nonaqueous electrolyte secondary battery according to claim 1, wherein the end voltage of the constant current charging is within a range from 3.5 to 3.8 V.

3. The nonaqueous electrolyte secondary battery according to claim 1, wherein when 1,000 cycles of constant current charging to an end voltage of not more than 3.8 V and constant current discharging to an end voltage of 2.5 V are repeated at a 3 C rate current, an initial 3 C discharge capacity rate determined by dividing a discharge capacity of a first cycle by a capacity when discharge capacity was confirmed in advance is 80% or higher.

4. The nonaqueous electrolyte secondary battery according to claim 1, wherein a current collector coating layer containing conductive carbon is present on at least a portion of a surface of the current collector on a side of the positive electrode active material layer.

5. The nonaqueous electrolyte secondary battery according to claim 1, wherein a current collector coating layer containing conductive carbon is present on at least a portion of a surface of the current collector on a side of the positive electrode active material layer, and
an active material coating portion containing a conductive material is present on at least a portion of surfaces of the positive electrode active material particles.

6. The nonaqueous electrolyte secondary battery according to claim 1, wherein the nonaqueous electrolyte contains a lithium imide salt.

7. The nonaqueous electrolyte secondary battery according to claim 6, wherein the lithium imide salt is represented by a formula (1) shown below:
LiN(SO₂R)₂ (1)
wherein R represents a fluorine atom or CₓF₍₂ₓ₊₁₎, and x represents an integer of 1 to 3.

8. The nonaqueous electrolyte secondary battery according to claim 1, wherein the positive electrode active material particles contain at least a compound represented by a general formula: LiFeₓM₍₁₋ₓ₎PO₄ (wherein 0≤x≤1, and M represents Co, Ni, Mn, Al, Ti or Zr).

9. The nonaqueous electrolyte secondary battery according to claim 1, wherein an amount of conductive carbon relative to a total mass of the positive electrode active material layer is at least 0.5% by mass but less than 3.5% by mass.

10. A battery module or battery system provided with a plurality of the nonaqueous electrolyte secondary batteries according to claim 1.

11. A battery module or battery system provided with a plurality of the nonaqueous electrolyte secondary batteries according to claim 2.

12. A battery module or battery system provided with a plurality of the nonaqueous electrolyte secondary batteries according to claim 3.

13. A battery module or battery system provided with a plurality of the nonaqueous electrolyte secondary batteries according to claim 4.

14. A battery module or battery system provided with a plurality of the nonaqueous electrolyte secondary batteries according to claim 5.

15. A battery module or battery system provided with a plurality of the nonaqueous electrolyte secondary batteries according to claim 6.

16. A battery module or battery system provided with a plurality of the nonaqueous electrolyte secondary batteries according to claim 7.

17. A battery module or battery system provided with a plurality of the nonaqueous electrolyte secondary batteries according to claim 8.

18. A battery module or battery system provided with a plurality of the nonaqueous electrolyte secondary batteries according to claim 9.
